(19) United States
(12) Patent Application Publication
(10) Pub. No.: US 2002/0016759 A1
(43) Pub. Date: Feb. 7, 2002

(54) Method and system for discovery of trades between parties

(76) Inventors: William G. Macready, Sante Fe, NM (US); Mohammed El-Beltagy, Sante Fe, NM (US); Barbeau A. Roy, San Francisco, CA (US); Mark A. Anderson, Santa Fe, NM (US)

Correspondence Address: PENNIE & EDMONDS LLP, 1667 K STREET NW, SUITE 1000, WASHINGTON, DC, 20006

(21) Appl. No.: 09/729,692

(22) Filed: Dec. 6, 2000

Related U.S. Application Data
(60) Provisional application No. 60/168,754, filed on Dec. 6, 1999.
(60) Provisional application No. 60/194,880, filed on Apr. 6, 2000.

(51) Int. Cl. G06F 17/60

(52) U.S. Cl. 705/37

(57) ABSTRACT

A system is described which allows buyers to define their preferences and sellers to define their capabilities, then determines which trading points maximize the utility of the buyer. The system suggests trades by exploiting the flexibilities and tradeoffs encoded by both parties, thus providing win-win trades. A second level of optimization ranks the trades with all suppliers, allowing the buyer to rapidly determine the best alternatives. The system allows for rich negotiation spaces and supports continuous, discrete, and range or interval decision factors.

### 1. RELATED APPLICATIONS

This application claims priority to provisional application Ser. No. 60/168,754 filed on Dec. 6, 1999, titled, “An E-Commerce Infrastructure for Value Chains”, the contents of which are herein incorporated by reference. This application also claims priority to provisional application Ser. No. 60/194,880, titled, “Method and System to Mediate Commerce”, filed on Apr. 6, 2000, the contents of which are herein incorporated by reference.

### 2. FIELD OF THE INVENTION

The invention relates to a method and system for discovery of trades between parties. In particular, the invention is a system which allows buyers to define their preferences and sellers to define their capabilities, then determines which trading points maximize the utility of the buyer. The system suggests trades by exploiting the flexibilities and tradeoffs encoded by both parties, thus providing win-win trades. A second level of optimization ranks the trades with all suppliers, allowing the buyer to rapidly determine the best alternatives. The system allows for rich negotiation spaces and supports continuous, discrete, and range or interval decision factors.

### 3. BACKGROUND OF THE INVENTION

The present invention relates to methods of automatic exploration and exploitation of the flexibilities possessed by negotiating parties to uncover improved win-win agreements. The invention describes computationally efficient mechanisms that are applicable whether there are one or many selling parties. The precise number and types of negotiating dimensions are irrelevant as long as they are numerical. Thus the present invention applies equally to the optimal determination of terms in the purchase of a commodity or an arbitrarily complex artifact.

The past 5-10 years have seen remarkable growth in software tools to help firms with enterprise-wide planning (ERP software) and supply chain management (SCM software). While these tools do a wonderful job at integrating disparate data sources within and between firms, the opportunity exists for significant further cost reductions.

The same time period has also seen a tremendous rise in the widespread use of the internet by both consumers and businesses. Forecasters are predicting that within a few years e-commerce between businesses (B2B) and between consumers and businesses (B2C) will grow to in excess of a trillion dollars per year in annual revenues.

Electronic markets have proliferated over the last few years with the advent of B2C (business-to-consumer) and B2B (business-to-business) electronic commerce. Such market places have yielded significant cost savings by lowering the transaction costs between buyers and sellers. Buyers have also profited through increased competition between suppliers. However, electronic markets have hurt suppliers, since the zero-sum negotiation over price has been at their expense. The present invention describes a tool whereby cost savings for both parties are derived from the discovery of win-win trades. Fundamentally, the system works by allowing trading parties to describe their desired trade across multiple dimensions and to express their flexibility around this ideal trade. Through an algorithmic exploration of their flexibilities, the present invention can discover trades that are near the ideal trades of both parties, enabling both to win.

The adoption of B2B and B2C electronic commerce was facilitated by the migration of catalogues online. This familiar method of presentation ameliorated the significant cultural change to electronic trade. For the foreseeable future, electronic commerce will be dominated by online catalogs. At present, online catalogues are direct translations of their hardcopy counterparts where the attributes of a product are described and a price quoted. Inevitably however, online catalogs will become more expressive. Catalog entries will be able to represent price breaks for large quantity orders, lot sizes, etc. Thus it is important that any software (like the present invention) that uncovers mutually beneficial trading scenarios is able to operate with such catalogs. Consequently, in the present invention there is an asymmetry between buyer (usually a human) and seller (usually an online catalog).

One of the reasons catalogs have come to dominate electronic commerce is that the types of goods that can be represented in catalogs are simple. Whether the product is pens or paper clips, different vendor's offers differ little from each other (a pen is a pen is a pen), and a quick scan of a catalog gives a buyer enough information to make an informed purchase. These types of goods are low margin and inexpensive. In contrast, the vast amount of purchasing between businesses involves materials which are directly connected with business operations—car parts, turbines, etc. Such direct goods are the future of electronic commerce. Unlike present-day engines, any truly useful procurement tool must be able to support direct materials with complex attributes and complex inter-relationships between its components.

Electronic commerce offers unprecedented opportunities for more informed decision-making for both buyers and sellers. The past few decades have seen the widespread adoption of enterprise resource planning (ERP) systems, to the point that now almost every major company has some form of ERP software. ERP functions as the digital nervous system of a company, transmitting and logging information between the company's many different business functions. ERP software keeps track of inventory, monitors the state of purchase orders, signals when a company should reorder direct and indirect materials, and a myriad of other functions. Consequently, ERP databases are a rich source of information to optimize a company's operations. Yet today this information is rarely used to make more informed buying and selling decisions. The present invention can utilize such information sources to optimize a company's interactions with suppliers and customers.

One important manner in which this optimization can occur is through an analysis of all cost factors. Current buying and selling practices often focus on limited goals, e.g., minimize the total purchase price. Myopic purchasing strategies often result in higher total cost of ownership when all cost factors relevant to a product in its lifetime of use are included. These other cost factors can be significant. Why save the money in taking delivery two days late if the receiving docks will be full at that time and an additional shift needs to be hired to clear the docks? Why order the cheaper drill bit if it is much more expensive to replace when it breaks? The present invention improves trades by minimizing the total cost of ownership of a product, yielding significant savings to its users. Many total cost factors are difficult to quantify—e.g. what is the cost of dealing with a unionized versus a non-unionized supplier? Consequently, the present invention supports qualitative (best guesses and intuition) as well quantitative factors.

All companies are situated in a supply or value chain. At each step in the chain, a company purchases from its suppliers, transforms these inputs, and sells the output to its customers. The termination of the supply chain is the sale of the final product to the end consumer. Since the only influx of external capital comes from the end consumer, companies have realized that they compete not only as individuals but also as entire supply chains. As result, software products have recently become available which attempt to streamline the operations of links within the entire supply chain. This software, variously called supply chain optimization (SCO) or advanced planning and optimization (APO), operates on the basis of forecasted demand at various points within the supply chain. Based on these predictions, plans are generated telling companies how much to produce and how to schedule their operations. SCO systems are a valuable source of intra-company information - data the present invention capitalizes on. Because SCO software relies on forecasted demand, it is only as helpful as the forecast is accurate, and, unfortunately, in many cases demand is very difficult to predict. How can the software know that laundry detergent will go on special at grocery stores in the Northeast in 7 weeks? As a result of the volatility in demand and the many other unpredictable perturbations that plague supply chains, companies keep significant buffers in the form of inventories. In addition to planning, businesses must also be able to adapt to unplanned effects. Such adaptation requires flexibility and a means to exploit that flexibility. The present invention exploits the flexibility of trading parties to streamline the operations of supply chains by smoothing the boundaries between trading parties.

The present invention is therefore a system to allow trading parties to express trading desires and constraints across many and varied different factors. These trading preferences are informed by many different data sources to optimize for a company's internal operations and its connections to it's supply chain through an analysis including total cost factors. The flexibility expressed by all trading parties is exploited to locate win-win opportunities for all parties if they exist.

### 4 SUMMARY OF THE INVENTION

We describe the present invention in its application to facilitating trade between buyers and sellers, but note that the mechanisms described are much more general. We can easily imagine, for example, using the present invention to match individuals (with the desires and skills) to projects.

The inspiration for the present invention comes from utility theory developed by economists since the 1960's. Since we are interested in multiple dimensions of negotiation, we draw from the multi-attribute utility theory literature.¹ Utility is an abstract concept which has been formalized in various ways. For the present purposes utility, u, is a number between 0 and 1 representing a party's willingness to trade. Larger values indicate a greater willingness. ¹For a good introduction to multi-attribute utility theory see [1].

4.1 The Negotiation Space

In any negotiation the parties must come to agreement on the factors requiring negotiation. We call these factors dimensions or variables. As an example, when purchasing a car, the buyer may be concerned with price, time of delivery, and color. Each factor price, time, and color is a dimension. Most dimensions can be classed as one of three types: continuous, discrete, or range/interval. A continuous dimension is one like price for which the buyer's utility varies smoothly across that dimension. The buyer's utility at $23 001.00 is almost the same as the utility at $23 000. Color is a discrete dimension. Since the car may only be available in black, white, and silver, the domain of this dimension is the finite set of values {black, white, silver}. Moreover, the buyer's utility may be quite different for the three colors. The third class of dimensions is called interval dimensions. An interval dimension arises often in B2B negotiations. If a machined part is built to some tolerance (e.g., the inner diameter of a screw is between 24.5 and 25.5 mm), the range of variability in the dimension is specified as an interval. In the language of statistical quality control, a certain percentage of the machined parts will fall in this range. These three broad classes of variables capture almost all the types of attributes relevant to B2B negotiation.

The present invention operates over any number of continuous, discrete, and range or interval variables. We call the negotiation space X and any point in the negotiation space (x, , r) ε X. It is important to recognize that the single trading point (x, , r) may have multiple components, e.g., price=$23 000, time of delivery=3 weeks, color =black.

In the present invention, the space of negotiation is agreed upon by all parties involved prior to the commencement of any negotiation. We can, however, imagine more dynamic situations in which dimensions are introduced and discarded over time.

4.2 The Buyer's Utility Function

A party defines it's utility function over this space so that every (x, , r) is assigned a utility number indicating the party's willingness to trade. We indicate the utility function as u((x, , r)). A great deal of work has been done on the appropriate form for utility functions. In the present invention, we take a simple form for the utility function for two reasons. First, we would like the form of the utility to be conducive to rapid computation. Second we would like the utility to be simple enough to be easily understood by and elicited from users of the invention. With no loss in generality, we write the utility function as u((x, , r))=exp(−d((x, , r))) where d(x) is interpreted as the distance of trading point (x, , r) from the most preferred trade.

So that we can operate against seller catalogs, only the buyer needs to define a utility function. Across the continuous dimensions, the buyer's utility is defined by specifying the most preferred (or ideal) continuous dimensions and the manner in which utility drops off as we move away from this ideal. For the discrete dimensions, the utility is specified in tabular form since there are a finite number of alternatives. Again, the buyer must specify it's ideal discrete values and how utility decays away from those values. In section 6.1 we describe how this is accomplished. The range dimensions contribute to utility similarly; the buyer specifies an ideal range and the utility decays for ranges other than the ideal according to their distance from the ideal.

The utility function can also express tradeoffs between variables, e.g., I may take delivery in 5 weeks if the price drops to $20 000, or I may accept the white car if I can take delivery in 2 weeks. The tradeoffs may be between pairs of continuous dimensions (as in the first case), between pairs of discrete variables, or between continuous and discrete variables (as in the second case).

4.2.1 Normalization and Weighting

When utility is defined over different types of variables, it is important to normalize the contributions of each variable so that the buyer can weight the importance of the various contributions to utility. This is a difficult problem. How should a buyer's color preferences be normalized so that they can be traded off against time of delivery? The present invention solves this problem by requiring that the average distance of any negotiation variable from its ideal value is the same for all dimensions. Since the buyer is more interested in those regions of the negotiation space where the utility is high, the average is weighted by utility. This procedure defines a manner in which to define a baseline where all dimensions contribute equally. Given this baseline, the buyer can then weight the various contributions and obtain useful results.

4.2.2 Utility Elicitation

Since utility is fundamental to the present invention, its elicitation from the buyer is important. Utility may be defined using any of a number of sources:

1. graphical user interfaces associated with the invention

2. standard benchmark criteria applicable to the domain

3. formal methodologies like the analytical hierarchical process [2], or discrete choice analysis [3]

4. inferred through models

We expand briefly upon method 4. As discussed in the background section, it is important to buyers to minimize their total cost of ownership. If we have a function representing these costs as a function of the negotiation variables, and perhaps other factors, this function can be used to infer a utility function which will act to minimize the total costs. Later we describe how this can be accomplished.

4.3 A Supplier's Capabilities

As noted previously, suppliers are treated differently from buyers so that the tool can operate against catalog information with no human intervention required on the part of the seller. In fact, we do not require sellers to define a utility at all.

A supplier cannot offer deals at all points within the negotiation space X, e.g., he certainly can't offer the black car tomorrow for free! A capability then represents the ability of a supplier to deliver and defines a subspace of X. It can include such things as price discounts on large volume orders, variation in delivery time as a function of price, etc. Since these relationships are already specified by businesses in terms of simple rules like “the price per unit is $10.00 if 1 to 999 units are ordered and $9.50 per unit if 1000 or more units are ordered”, suppliers' capabilities are represented in the present invention by piecewise linear functions.

4.4 Negotiation Constraints

Both parties may have constraints which must be satisfied in order for them to trade. For example, the buyer may not buy the car unless he gets it within 6 weeks, or he may not purchase the car if it is available only in white. These are examples of continuous and discrete constraints, respectively. A continuous constraint sets a requirement on the continuous variables. In the present invention, continuous constraints must be either linear or quadratic. Discrete constraints involve discrete variables. A discrete constraint can be expressed as a list of the allowed (or disallowed) combinations of the discrete variables for which the trade will be acceptable. For example, if the buyer would accept either the black or the silver car, the constraint would list both these colors as viable. It is important to note that both continuous and discrete constraints may involve one or more variables. We can also express constraints involving both types of variables by allowing the continuous constraints to differ depending on the discrete variables.

4.5 Utility Optimization

With the major components of the invention in place, we describe how the overall system works. As a procurement tool for the buyer, there are two levels of optimization. First, for any given supplier we maximize the buyer's utility, subject to the supplier's capabilities to find that trade which makes the buyer as happy as possible. Since we are optimizing within a supplier's capabilities, the supplier has expressed a willingness to complete the trade at whatever point is determined to be optimal. The tool then optimizes across suppliers to rank them according to utility at the optimal point. A graphical user interface allows a buyer to investigate the trades suggested by the tool by sorting according to any dimension or by the overall utility.

Utility, while a useful concept in assessing an overall score, may be of limited use to a buyer due to its abstract meaning. Consequently, we can also apply the total cost of ownership function to the results to rank order the suggested trades according to their various cost components. Recall that for any trade x ε X, the total cost of ownership function returns the various cost contributions. This additional information aids the buyer in his purchasing decision. The utility number for each trade is still useful because the total cost of purchase function includes only those cost factors which can be quantified, whereas the utility also includes “softer” qualitative factors.

4.5.1 Aggregation

In addition to optimizing against one supplier at a time, the present invention can also be used to optimize against an arbitrary aggregation of suppliers. This is important if, for example, no single seller can supply the large volume requested by a buyer. In this mode of operation, the buyer specifies sets of suppliers participating in the aggregation and the dimensions over which aggregation can occur, and the tool finds the optimal combination in which to distribute the volume dimension over the allowed suppliers.

4.6 An e-Commerce Infrastructure for Value Chains

This patent application also describes an integrated solution for B2C and B2B e-commerce that would be built on top of ERP and SCM software and which would provide a number of compelling benefits to companies. Amongst the benefits are:

multidimensional markets which allow consumers to implicitly define their preferences over many criteria. This allows both consumers to express what it is they really value, allows companies to position themselves clearly in the space of value, and allows for efficient matches between trading partners

optional anonymity of market participants and their trading desires when that is appropriate² ²Anonymity is not, however, a pre-requisite of the proposed invention.

explicit pricing of the flexibility possessed by the consumer and all businesses in the supply chain which allows for more robust operation of the entire supply chain. This concept is very different from other types of markets (e.g. auctions, reverse auctions, exchanges) where transactions are specified exactly. The flexibility introduced by any party, whether consumer or supplier, is propagated and exploited through the entire supply chain.

capture and quantification of true consumer demand leading to improved forecasting and product development by suppliers

automated markets that integrate supply chain networks through coordination across and within company boundaries. Coupling of the automated markets with local (i.e. at the company level) optimization tools fed by real-time company data allows for optimization and cost savings across the entire supply chain.

It should be recognized that supply chains may be very different in the near future. Current supply chains are based on physical objects made valuable through a sequence of transformations resulting in a product purchased by an end consumer. With the move to an information economy the supply chain of the near future may not involve physical goods at all. In particular the entire supply chain may consist of value adding operations converting raw data to consumer-desired information. Such supply chains will have the same coordination problems current ones do. Our proposed solution applies equally well to these future supply chains and by supply chain we mean this more general notion.

### 5 BRIEF DESCRIPTION OF THE FIGURES

FIG. 1 shows an architecture for the invention.

FIG. 2 shows a schematic of a buyer-specific capability with examples indicating potential input.

FIG. 3 shows a schematic of a supplier-specific preference with examples indicating potential input.

### 6 DETAILED DESCRIPTION

6.1 Theory

In this section we outline the mathematical foundations of the optimization process in sufficient detail to allow for computer implementation.

6.1.1 The Negotiation Space

In Table 1 we define the parameters which collectively define the space of negotiation X. For each of the n_{c} continuous variables, we specify an allowed range over which that continuous dimension may vary as xᵢ ε Xᵢ=[xᵢ, \overline{x}ᵢ], where x is the n_{c}-vector of lower continuous bounds

TABLE 1
Definition of the negotiation search space.

| | |
|---|---|
| n_{c} | number of continuous dimensions |
| n_{d} | number of discrete dimensions |
| nᵣ | number of range dimensions |
| x | n_{c}-vector of values for continuous dimensions |
| κ | n_{d}-vector of values for continuous dimensions |
| χᵢ | value of ith continuous variable |
| κᵢ | value of ith discrete variable |

and \overline{x} is the n_{c}-vector of upper continuous bounds. Each discrete variable assumes a value from within its domain nᵢ ε Dᵢ. Without loss of generality, we label the domain of discrete variable i by Dᵢ=[1, . . . , dᵢ] where dᵢ≧0 is an integer giving the number of possible values discrete variable ᵢ may assume.

With these definitions, we define the space of negotiation by the tensor product X=X₁ \mathring{x} . . . \mathring{x} Xₙ_{_{c}} \mathring{x} D₁ \mathring{x} . . . \mathring{x} Dₙ_{_{d}}. Range variables are treated separately and not negotiated over.

6.1.2 The Utility Function

The utility function is a mapping from X into the interval [0, 1]. As indicated earlier we assume the utility to have the form u(x, )=exp[−d(x, )] where d(x, ) is interpreted as a distance. In what follows we will assume that in its simplest form the distance function has the form

d(x, ,r)=(x−μ))^{t}C⁻¹(n)(x−μ(x))+Z(n)+R(r; x).

Each contribution to the distance function is positive. We consider each contribution to the distance in turn, beginning with the range variable contribution R(r; ).

First, we note that the range distance depends on the setting of the discrete variables. This allows the buyer to express different preferences for the range variables depending on discrete factors. The total range distance is summed up over all possible range variables so that R(r; )=Σᵢ₌₁ⁿ_{ᵣ} Rᵢ(rᵢ; n). The vector r indicates the preferred values for all range variables. If range variable i is specified as the interval rᵢ≡(rᵢ, \overline{r}ᵢ) (where \overline{r}ᵢ>rᵢ) then r is an nᵣ-vector of such tuples. The distance contribution, Rᵢ, from one range variable will depend on the application. If the range variables are meant to represent the tolerances on machined parts where issues of statistical quality control are important, then the distance between two ranges might be related to the overlap between Gaussian distributions. If rᵢ is interpreted as a Gaussian having mean (rᵢ+\overline{r}ᵢ)/2 and standard deviation proportional to \overline{r}ᵢ−rᵢ then an appropriate range distance is given in Appendix A. Other choices for the range distance function are certainly possible.

The continuous distance is quadratic and determined by the positive semidefinite n_{c}×n_{c} matrix C⁻¹. We have allowed this matrix to vary with the setting of the discrete variables and indicated this explicitly through C⁻¹ ( ).³ The n_{c}-vector μ may also depend on and indicates the point at which the utility is maximal −μ is thus identified with the ideal value for the continuous variables. The precise quadratic form is convenient, but, using recent developments in interior point methods, other convex functions are also computationally tractable [4]. ³Where no confusion will arise we eliminate the dependence of C⁻¹ on for notational simplicity.

The discrete distance is determined through the function Z( ) which maps the discrete space D₁ \mathring{x} . . . \mathring{x} Dₙ_{_{d}} onto the positive real line [0, ∞]. In keeping with the assumption that distance is a function of only pairs of components xᵢ, xⱼ, we assume the discrete distance has the form⁴

$$Z ( ϰ ) = {\sum }_{i = 1}^{{n}_{d}} \{ {Z}_{i} ( {ϰ}_{i} ) + {\sum }_{j = 1 ( \neq i )}^{{n}_{d}} {Z}_{i , j} ( {ϰ}_{i} , {ϰ}_{j} ) \} .$$

Each contribution Z_{i,j} is a table consisting of dᵢdⱼ entries, where Z_{i,j}( ᵢ, ⱼ) can be interpreted as the distance if discrete dimension i has value ᵢ conditioned on discrete dimension j having value ⱼ. The diagonal terms Zᵢ offer an unconditional distance. The most preferred value for the ith discrete dimension is that for which Zᵢ( ᵢ)=0. ⁴Later we shall generalize this distance to include weighting of dimensions.

Rather than require the user to enter the distances explicitly, there are numerous ways in which the distances can be generated automatically based upon a buyer's ranking of preferred values. Further details can be found in Appendix B.

Weighting of Dimensions

In many cases it is important for simple modifications of the distance function to re-weight the contributions to the total distance. If w_{c} is an n_{c}-vector of weights for the continuous dimensions, we can accomplish this by letting C_{w}⁻¹=W_{c}C⁻¹W_{c} where W_{c} is the diagonal matrix W_{c}=diag(w_{c}).⁵ In a similar way we modify the discrete distance to Z_{w,i,j}( ᵢ, ⱼ)=W_{d;i}W_{d;j}Z_{i,j}( ᵢ, ⱼ) where w_{d} is the n_{d}-vector of weights for the discrete variables and W_{d;i} is its ith component. The range contribution is also modified so that R_{w;i}(rᵢ)=w_{r;i}Rᵢ(rᵢ) where wᵣ is the nᵣ-vector of weights for the range variables and w_{r;i} is its ith component. For convenience the weights are normalized so that (1^{t}w_{c})²+(1^{t}w_{d})²+1^{t}wᵣ=1. With little additional complexity the dimension weights can be made dependent on the setting of the discrete variables but we will assume throughout that the weights are constant. ⁵M=[m_{i,j}]=diag(ν) is the diagonal matrix formed by setting m_{i,i=θ}ᵢ and m_{i,j}=0 for j≢i.

With these modifications, the total distance function becomes

d(x, )=(x−μ( ))^{t}C⁻¹_{w}( )(x−μ( ))+Z_{w}( ))+Z_{w}( )+R_{w}(r) (1)

where Z_{w}( )=Σᵢ₌₁ⁿ_{_{d}} w_{d;i}{w_{d;i}Zᵢ( ᵢ)=Σ_{j=1(≢i)}ⁿ_{_{d}} w_{d;j}Z_{i;j}( ᵢ, ⱼ)} and R_{w}(r)=Σᵢ₌₁ⁿ_{ᵣ} w_{r;i}Rᵢ(rᵢ)

Assigning weighting factors is useful only if the relevant contributions have been previously normalized so that they are all roughly the same magnitude. This serves as the baseline for which all weights are equal. The question immediately arises as to what criteria to use to weight the distance contributions.

We shall determine scaling factors, Q_{d}>0 and Qᵣ>0, so that the average distances per dimension of the discrete, range, and continuous contributions are equal, where by average we mean a utility-weighted average over the entire space of possible trades. This weighting places more emphasis on the better trades

If d_{c}, d_{d}, and dᵣ are the continuous, discrete, and range contributions to the total distance, then after multiplication by the scaling factors d=d_{c}+Q_{d}d_{d}+Qᵣdᵣ. The scaling factors are determined through the utility weighted average distances defined by

$$\begin{matrix}( {d}_{r} ) ≡ \frac{{\sum }_{ϰ} {\sum }_{r} {\int }_{V} ⅆ {uQ}_{r} {d}_{r} exp [ - {Q}_{r} {d}_{r} - {Q}_{d} {d}_{d} - {d}_{c} ]}{{\sum }_{ϰ} {\sum }_{r} {\int }_{V} ⅆ u exp [ - {Q}_{r} {d}_{r} - {Q}_{d} {d}_{d} - {d}_{c} ]} \\ = {Q}_{r} {\sum }_{ϰ} \frac{exp [ - {Q}_{d} {d}_{d} ] {\sum }_{r} {d}_{r} exp [ - {Q}_{r} {d}_{r} ] {\int }_{V} ⅆ u exp [ - {d}_{c} ]}{{\sum }_{ϰ} exp [ - {Q}_{d} {d}_{d} ] {\sum }_{r} {d}_{r} exp [ - {Q}_{r} {d}_{r} ] {\int }_{V} ⅆ u exp [ - {d}_{c} ]}\end{matrix}$$

$$\begin{matrix}( {d}_{d} ) ≡ \frac{{\sum }_{ϰ} {\sum }_{r} {\int }_{V} ⅆ {uQ}_{d} {d}_{d} exp [ - {Q}_{r} {d}_{r} - {Q}_{d} {d}_{d} - {d}_{c} ]}{{\sum }_{ϰ} {\sum }_{r} {\int }_{V} ⅆ u exp [ - {Q}_{r} {d}_{r} - {Q}_{d} {d}_{d} - {d}_{c} ]} \\ = {Q}_{r} {\sum }_{ϰ} \frac{{d}_{d} exp [ - {Q}_{d} {d}_{d} ] {\sum }_{r} exp [ - {Q}_{r} {d}_{r} ] {\int }_{V} ⅆ u exp [ - {d}_{c} ]}{{\sum }_{ϰ} exp [ - {Q}_{d} {d}_{d} ] {\sum }_{r} exp [ - {Q}_{r} {d}_{r} ] {\int }_{V} ⅆ u exp [ - {d}_{c} ]}\end{matrix}$$

$$\begin{matrix}( {d}_{c} ) ≡ \frac{{\sum }_{ϰ} {\sum }_{r} {\int }_{V} ⅆ {ud}_{c} exp [ - {Q}_{r} {d}_{r} - {Q}_{d} {d}_{d} - {d}_{c} ]}{{\sum }_{ϰ} {\sum }_{r} {\int }_{V} ⅆ u exp [ - {Q}_{r} {d}_{r} - {Q}_{d} {d}_{d} - {d}_{c} ]} \\ = {Q}_{r} {\sum }_{ϰ} \frac{exp [ - {Q}_{d} {d}_{d} ] {\sum }_{r} exp [ - {Q}_{r} {d}_{r} ] {\int }_{V} ⅆ u {d}_{c} exp [ - {d}_{c} ]}{{\sum }_{ϰ} exp [ - {Q}_{d} {d}_{d} ] {\sum }_{r} exp [ - {Q}_{r} {d}_{r} ] {\int }_{V} ⅆ u exp [ - {d}_{c} ]}\end{matrix}$$

A few comments on the above equations are in order. First, Σ indicates the repeated sum Σₓ_{₁} . . . Σₓ_{ₙ}_{_{d}} over all possible discrete trades. Σᵣ indicates a sum over all the range variables and the integral over volume V indicates integration over the continuous trading volume of interest. Finally, we have not included a scaling factor Q_{c} on the continuous distance, since this can be made equal to 1 if we reinterpret Qᵣ as Qᵣ/Q_{c} and Q_{d} as Q_{d}/Q_{c}.⁶ Each of the averages is an explicit function Q_{d} and Qᵣ. ⁶We singled the continuous variables out, since there will always be continuous variables in any trading scenario.

The requirement on equal average contributions determines the two unknowns Qᵣ and Q_{d} through the equations: (dᵣ)/nᵣ=(d_{c})/n_{c} and (d_{d})/n_{d}=(d_{c})/n_{c}. These two nonlinear equations are coupled in terms of Qᵣ and Q_{d} and must be solved simultaneously for Qᵣ and Q_{d}. Further details are found in Appendix C.

6.1.3 Constraint Specification

Buyers and sellers may express constraints over both continuous and discrete variables.

Continuous Constraints

For simplicity (and because additional expressiveness is rarely required) we assume that the buyer's constraints over the continuous variables are linear.⁷ This allows a buyer to express a constraint, e.g., the time of delivery must be within 10 days or I will not trade, i.e., t≦10. We allow for both inequality and equality constraints which can be expressed as G₁^{(b)}x=g₁^{(b)} and G₂^{(b)}x≦g₂^{(b)}. If there are c₁^{(b)} equality constraints then G₁^{(b)} has c₁^{(b)} rows. Similarly, G₂^{(b)} has c₂^{(b)} rows if there are c₂^{(b)} inequality constraints. We allow the constraints to depend on the setting of the discrete variables, and to be explicit we often write G₁^{(b)} ( ), g₁^{(b)} ( ), G₂^{(b)} ( ), and g₂^{(b)} (x). ⁷With little additional complexity we can also handle quadratic constraints, see [4].

Discrete Constraints

We use a standard methodology to represent and process constraints over discrete variables [5]. Abstractly, a constraint over a (perhaps proper)⁸ subset of the discrete variables is represented as a list of all the allowed combinations the variables may assume. An example representation of a pair of discrete constraints is given in Table 2. There are two solutions to this set of constraints: of ₁1, ₂=2, ₃=3 and ₁=3, ₂=2, ₃=1. We indicate these solutions as {( ₁; 1), ( ₂,2)}, ( ₃,3)}} and {( ₁, 3), ( ₂,2)}, ( ₃,1)}} respectively. Each solution where

TABLE 2
An example set of constraints involving 3 variables where the domains
of all variables are D₁ = D₂ = D₃ = {1, 2, 3}. Constraint (a) requires
that the values assumed by κ₁, κ₂, and κ₃ are all different from each other,
and constraint (b) requires that the value assumed by κ₂ is even.
See text for the solution to both constraints.

| κ₁ | κ₂ | κ₃ |
|---|---|---|
| 1 | 2 | 3 |
| 1 | 3 | 2 |
| 2 | 1 | 3 |
| 2 | 3 | 1 |
| 3 | 1 | 2 |
| 3 | 2 | 1 |

(a)
κ₂
2
(b)

all the variables have been identified with specific values from their domains is called a labelling. 8A proper subset of a set is the set itself.

Computationally efficient representations are used to ensure that only feasible combinations of variables are ever processed. Numerous third-party libraries offer constraint programming functionality.⁹ ⁹See for example www.mozart-oz.org or www.ilog.com.

6.1.4 Utility and Total Cost of Ownership

The buyer's utility function and associated constraints may be difficult for many users to define. In this section we show how models of the buyer's business can be used to define utility in a natural manner.

We imagine a function which provides an estimate of the total cost of ownership for any given purchase. Cost contributions to this function might include piece part costs, freight costs, setup costs, quality assurance costs, repair costs, etc. It is important to include all quantifiable costs associated with the lifetime of use of the purchased product because it is this function we will be minimizing. Significant savings may be obtained by taking a longer-term view of the purchase. Revenues (negative costs) generated from the purchase are also included in the function so that the function represents some measure of profitability associated with the purchase. We write the total cost of ownership function as Cₒ(x, , r; β). We explicitly indicate the dependence on the negotiated trade parameters x, , and r, as well as other factors β. The other factors might include forecasted demand, current inventory levels, etc. These factors will vary over time, and they can be extracted from the buyer's ERP and supply chain management systems (SCM) in real-time just before the purchase to ensure continuous real-time optimization. See section 6.2.1 for further details.

Minimization of Cₒ(x, , r; β) defines an ideal trade dependent on current conditions: xₒₚₜ(β), ₒₚₜ(β), rₒₚₜ(β). If desired, these can be used to define μ=xₒₚₜ(β, r=rₒₚₜ(β) and the desired ideal discrete configuration ₒₚₜ(β) (having distance contribution Z=0). Moreover, the tradeoffs between continuous dimensions around this minimum can be obtained through calculation of the Hessian matrix H=[h_{i,j}] where the i, j matrix element is given by

$${{h}_{i , j} = \frac{{\partial }^{2} {C}_{o} ( x , ϰ , r ; β )}{\partial {x}_{i} \partial {x}_{j}} \vert}_{x = {x}_{opt} ( β ) , ϰ = {ϰ}_{opt} ( β ) , r = {r}_{opt} ( β )}$$

We then identify C⁻¹ with H. In this way, little trading flexibility is obtained in directions where total cost of ownership rises rapidly, while significant flexibility is obtained in directions where total cost of ownership increases slowly.

In summary, a total cost of ownership model defines both the most preferred trade parameters and the flexibility possessed around the preferred trade. The model pulls dynamically from real-time data sources to provide the most up-to-date optimization based on total costs of ownership and other important qualitative factors the buyer may wish to describe in the utility function. The same function and its constituent costs may also be used to help analyze proposed trades from suppliers.

6.1.5 Supplier Capabilities

As discussed in the introduction, suppliers represent their capabilities through a specification of the subspace of X in which they will trade. A supplier's capabilities must specify the allowed continuous, discrete, and range variables. The allowed range variables are expressed as the pairs (rⱼ, \overline{r}ⱼ), one for each range variable. For example, if a supplier produces 25 mm inner diameter screws to within a tolerance of 0.5 mm, then the range variable is simply (24.5, 25.5). These are compared with the buyer's ideal range and contribute to the distance function through the R_{w}( ) function.

Capabilities over continuous and discrete variables are more complex. Continuous Capabilities

Continuous capabilities are viewed naturally as responses to a buyer's request. Thus we distinguish between a buyer's requested continuous vector x^{(b)} and a seller's response x^{(s)}. A vector-valued function, f(x^{(b)}, x^{(s)} ) returns the response based on the buyer's request and also, perhaps, other previously defined supplier responses. Component fᵢ of f defines the ith continuous variable, i.e. xᵢ^{(s)}=fᵢ(x^{(b)}, x^{(s)}).

Currently, suppliers are used to quoting price discounts for large volume orders and these price discounts are expressed as piecewise linear functions. Consequently, we restrict fᵢ to have the following form (where we distinguish between the functions depending on the buyer and seller variables):

$${x}_{i}^{( s )} = {\sum }_{k} {f}_{i , k}^{( s )} ( {x}_{k}^{( s )} , {ϰ}^{( s )} ) + {f}_{i , j}^{( b )} ( {x}_{k}^{( b )} , {ϰ}^{( s )} ) . \qquad ( 2 )$$

An example of how this may be used to define a supplier response is the following: We assume three continuous dimensions—price, volume, and time of delivery and indicate these as [x₁, x₂, x₃]=[p, θ, t]. Then a response may be formed as

v^{(s)}=f_{v,v}(v^{(b)})

t^{(s)}=fₜ(v^{(s)},t^{(b)}=f_{t,v}(v^{(s)})

p^{(s)}=fₚ(v^{(s)},t^{(s)}=f_{p,v}(v^{(s)})+f_{p,t}(t^{(s)}).

The f_{v,v} function returns the volume a supplier will fulfill as a function of what the buyer asked for. If the supplier can deliver any volume, this will be the identity function. If the supplier delivers only in certain lot sizes, this function may have a staircase shape, etc. The f_{t,v} function indicates the time it will take a supplier to deliver a certain volume. So, for example, if larger shipments require longer transportation, then this dependence is given by this function. Finally, we turn to the price determination. In this example the price depends on the quantity v^{(s)} being shipped and the f_{p,v} might represent price discounts for large volume orders. There is also an incremental price contribution based on the time of delivery. If faster delivery is more expensive, this is reflected in f_{p,t}.

For a given setting of the discrete variables, each f_{i,k}^{(s)}(xₖ^{(s)}, ^{(s)} and f_{i,k}^{(b)}(xₖ^{(b)}, ^{(s)}) is a one-dimensional piecewise linear function. Consequently, the functions can be specified by listing the breakpoints. If f_{i,k}^{(s)}(xₖ^{(s)}, ^{(s)}) has k_{i,k}^{(s)} breakpoints, then we list these as {xₖ^{(s)}(b_{i,k}^{(s)}=1), xₖ^{(s)}(b_{i,k}^{(s)}=2), . . . , xₖ^{(s)}(b_{i,k}^{(s)}=k_{i,k}^{(s)})}¹⁰ and function values at these breakpoints are {f_{i,k}^{(s)}(xₖ^{(s)}(b_{i,k}^{(s)}=1)), f_{i,k}^{(s)}(xₖ^{(s)}(b_{i,k}^{(s)}=2)), . . . , f_{i,k}^{(s)}(xₖ^{(s)}(b_{i,k}^{(s)}=k_{i,k}^{(s)}))}. Similarly, f_{i,k}^{(b)}, is a piecewise linear function defined by the k_{i,k}^{(b)} breakpoints {xₖ^{(b)}(b_{i,k}^{(b)}=1), xₖ^{(b)}(b_{i,k}^{(b)}=2), . . . , xₖ^{(b)}(b_{i,k}^{(b)}=k_{i,k}^{(b)})} and function values at these breakpoints {f_{i,k}^{(b)}(xₖ^{(b)}(b_{i,k}^{(b)}=1)), f_{i,k}^{(b)}(xₖ^{(b)}(b_{i,k}^{(b)}=2)), . . . , f_{i,k}^{(b)}(xₖ^{(b)}(b_{i,k}^{(b)}=k_{i,k}^{(b)}))}. The breakpoints are indexed by the integers b_{i,k}^{(s)} and b_{i,k}^{(b)}. ¹⁰The breakpoints are assumed to be in increasing order.

An interval is specified by assigning a value b_{i,k}^{(s)}ε[1,k_{i,k}^{(s)}−1] and b_{i,k}^{(b)}ε[1,k_{i,k}^{(b)}=1] so that¹¹

xₖ^{(s)}(b_{i,k}^{(s)})≦xₖ^{(s)}≦xₖ^{(s)}(b_{i,k}^{(s)}+1)∀i and xₖ^{(b)}(b_{i,k}^{(b)})≦xₖ^{(b)}≦xₖ^{(b)}(b_{i,k}^{(b)}+1)∀i. (3)

Within each interval the functions are linear, so we have

$${x}_{i}^{( s )} = {c}_{i} ( {ϰ}^{( s )} , \{ {b}_{i , k}^{( s )} \} , \{ {b}_{i , k}^{( b )} \} ) + {\sum }_{k} {m}_{i , k}^{( s )} ( {ϰ}^{( s )} , {b}_{i , k}^{( s )} ) {x}_{k}^{( s )} + {m}_{i , k}^{( b )} ( {b}_{i , k}^{( b )} ) {x}_{k}^{( b )}$$

where cᵢ(v^{(s)}, {b_{i,k}^{(s)}}, {b_{i,k}^{(b)}})=Σₖc_{i,k}^{(s)}( ^{(s)},b_{i,k}^{(s)})+c_{i,k}^{(b)}(b_{i,k}^{(b)}). In the above equations, the intercepts and slopes are given explicitly by

$${c}_{i , k}^{( s )} ( {b}_{i , k}^{( s )} ) = \frac{{x}_{k}^{( s )} ( {b}_{i , k}^{( s )} + 1 ) {f}_{i , k}^{( s )} ( {x}_{k}^{( s )} ( {b}_{i , k} ) ) - {x}_{k}^{( s )} ( {b}_{i , k} ) {f}_{i , k}^{( s )} ( {x}_{k}^{( s )} ( {b}_{i , k} + 1 ) )}{{x}_{k}^{( s )} ( {b}_{i , k}^{( s )} + 1 ) - {x}_{k}^{( s )} ( {b}_{i , k} )}$$

$$and$$

$${m}_{i , k}^{( s )} ( {b}_{i , k}^{( s )} ) = \frac{{f}_{i , k}^{( s )} ( {x}_{k}^{( s )} ( {b}_{i , k}^{( s )} + 1 ) ) - {f}_{i , k}^{( s )} ( {x}_{k}^{( s )} ( {b}_{i , k} ) )}{{x}_{k}^{( s )} ( {b}_{i , k}^{( s )} + 1 ) - {x}_{k}^{( s )} ( {b}_{i , k}^{( s )} )}$$

¹⁰Note that many choices for {b_{i,k}^{(s)}} or {b_{i,k}^{(b)}} would be inconsistent with these constraints. A simple way to fix this is to define a union of all breakpoints (s) and (b), and have all f_{i,k} have the same breakpoints.

respectively. An analogous result holds for the c_{i,k}^{(b)}(b_{i,k}^{(b)} and m_{i,k}^{(b)}(b_{i,k}^{(b)}).

To eliminate any cyclic dependence on xᵢ^{(s)} we must impose an ordering on xᵢ^{(s)} so that xᵢ^{(s)} can only depend on xⱼ^{(s)} where j<i. Consequently, we can write

$$\begin{matrix}{x}_{i}^{( s )} = {c}_{i} ( {ϰ}^{( s )} , \{ {b}_{i , 1}^{( s )} , … , {b}_{i , i - 1}^{( s )} \} , \{ {b}_{i , k}^{( b )} \} ) + \\ {\sum }_{k < i} {m}_{i , k}^{( s )} ( {ϰ}^{( s )} , {b}_{i , k}^{( s )} ) {x}_{k}^{( s )} + {\sum }_{k} {m}_{i , k}^{( b )} ( {b}_{i , k}^{( b )} ) {x}_{k}^{( b )} .\end{matrix}$$

Written as a matrix equation, the above becomes

(I−M^{(s)}( ^{(s)},{b_{i,k}^{(s)}}))x^{(s)}=c(x^{(s)},{b_{i,k}^{(s)}},{b_{i,k}^{(b)}})+M^{(b)}({b_{i,k}^{(b)}})x^{(b)}

where c(x^{(s)}, {b_{i,k}^{(s)}}, {b_{i,k}^{(b)}})=[c₁(x^{(s)}, {b_{i,k}^{(s)}}, {b_{i,k}^{(b)}}) . . . cₙ(x^{(s)}, {b_{i,k}^{(s)}, }b_{i,k}^{(b)}})]⁶, x^{(s)}=[x₁^{(s)} . . . xₙ_{_{c}}^{(s)}]^{t}, x^{(b)}=[x₁^{(b)} . . . xₙ_{_{c}}^{(b)}]^{t}, and

$${M}^{( s )} ( {ϰ}^{( s )} , \{ {b}_{i , k}^{( s )} \} ) = [ \begin{matrix}0 & 0 & ⋯ & 0 & 0 \\ {m}_{2 , 1}^{( s )} ( {ϰ}^{( s )} , {b}_{2 , 1}^{( s )} ) & 0 & ⋯ & 0 & 0 \\ {m}_{3 , 1}^{( s )} ( {ϰ}^{( s )} , {b}_{3 , 1}^{( s )} ) & {m}_{3 , 2}^{( s )} ( {ϰ}^{( s )} , {b}_{3 , 2}^{( s )} ) & ⋯ & 0 & 0 \\ ⋮ & ⋮ & ⋰ & ⋮ & ⋮ \\ {m}_{n , 1}^{( s )} ( {ϰ}^{( s )} , {b}_{n , 1}^{( s )} ) & {m}_{n , 2}^{( s )} ( {ϰ}^{( s )} , {b}_{n , 2}^{( s )} ) & ⋯ & {m}_{n , n - 1}^{( s )} ( {ϰ}^{( s )} , {b}_{n , n - 1}^{( s )} ) & 0\end{matrix} ]$$

$$and$$

$${M}^{( b )} ( \{ {b}_{i , k}^{( b )} \} ) = [ \begin{matrix}{m}_{1 , 1}^{( b )} ( {b}_{1 , 1}^{( b )} ) & {m}_{1 , 2}^{( b )} ( {b}_{1 , 2}^{( b )} ) & ⋯ & {m}_{1 , n}^{( b )} ( {b}_{1 , n}^{( b )} ) \\ {m}_{2 , 1}^{( b )} ( {b}_{2 , 1}^{( b )} ) & {m}_{2 , 2}^{( b )} ( {b}_{2 , 2}^{( b )} ) & ⋯ & {m}_{2 , n}^{( b )} ( {b}_{2 , n}^{( b )} ) \\ ⋮ & ⋮ & ⋰ & ⋮ \\ {m}_{n , 1}^{( b )} ( {b}_{n , 1}^{( b )} ) & {m}_{n , 2}^{( b )} ( {b}_{n , 2}^{( b )} ) & ⋯ & {m}_{m , n}^{( b )} ( {b}_{n , n}^{( b )} )\end{matrix} ] .$$

In most cases x^{(s)} will depend only on a subset of the variables in x^{(b)}. If x^{(s)} depends on n′<n of the x^{(b)} variables, then M^{(b)} is an n×n′ matrix. In the example given everything depending only upon the volume the buyer requested.

Since M^{(s)}( ^{(s)}) is lower triangular and can be inverted in time θ(n), we can rapidly express x^{(s)} as

x^{(s)}=(I−M^{(s)}( ^{(s)},{b_{i,k}^{(s)}}))⁻¹c( ^{(s)},{b_{i,k}^{(s)}},{b_{i,k}^{(b)}})+(I−M^{(s)}( ^{(s)},{b_{i,k}^{(s)}}))⁻¹M^{(b)}({b_{i,k}^{(b)}})x^{(b)} (4)

as long as the b_{i,k}^{(s)} are chosen to also satisfy xₖ^{(s)}(b_{i,k}^{(s)})≦xₖ^{(s)}≦xₖ^{(s)}(b_{i,k}^{(a)}−1). These constraints will be used in section 6.1.6 which formulates the optimization problem.

We also allow a supplier to express additional linear constraints so that, for example, he may represent that he does not deliver on Sunday. Thus the supplier may define the matrices Gₐ^{(s)} ( ), G₂^{(s)} ( ), and the vectors g₁^{(s)} ( ), g₂^{(s)} ( ) such that G₁^{(s)}x^{(s)=g}₁^{(s)} and G₂^{(s)}x^{(s)}x≦g₂^{(s)}. G₁^{(s)} ( ) and G₂^{(s)} (x) have c₁^{(s)} and c₂^{(s)} rows respectively.

Discrete Capabilities

It is easy to imagine that a supplier's response on a discrete dimension is highly constrained by the values of the response on other dimensions, e.g., certain product characteristics come only in certain colors and package sizes. Consequently, it is not suitable to explicitly define a response but only to make available a supplier's constraints amongst the discrete variables. Consider 3 discrete dimensions where ₁ ε D₁=[a, b, c], ₂ ε D₂=[A, B, C, D], and ₃ ε D₃=[α, β, γ, δ], and assume the supplier has the following 3 constraints

C₁( ₁, ₃)={(a,α),(a,β),(b,β),(c,β)},C₂( ₂, ₃)={(A,β),(B,γ),(D,β)},C₃( ₁)={b,c}.

We first note that there are 4 feasible solutions (or product configurations the supplier can meet): [ ₁, ₂, ₃]=[b, A, β], [b, D, β], [c, A, β], or [c, D, β]. Feasible solutions to the constraints define the response ^{(s)} for the discrete variables.

We indicate a supplier's or buyer's collective set of discrete constraints by C^{(s)} ( ) and C^{(b)} ( ) respectively.

6.1.6 The Optimization Problem

Having defined the necessary components, we now define the optimization task which determines the continuous x* and discrete x* parameters of the trade.

Since the trade must be acceptable to the supplier, we maximize the buyer's utility over a supplier's capabilities. Equivalently, we minimize the distance from the buyer's ideal values as

$$\begin{matrix}[ {x}^{*} , {ϰ}^{*} ] = {arg min}_{{x}^{( x )} , {ϰ}^{( s )}} \{ {( {x}^{( s )} - μ ( {ϰ}^{( s )} ) )}^{t} {C}_{w}^{- 1} ( {ϰ}^{( s )} ) ( {x}^{( s )} - μ ( {ϰ}^{( s )} ) ) + \\ {Q}_{d} {Z}_{w} ( {ϰ}^{( s )} ) + {Q}_{r} {R}_{w} ( w ) \}\end{matrix}$$

where

x^{(s)}=(I−M^{(s)}( ^{(s)}))⁻¹c( ^{(s)})+(I−M^{(s)}(x^{(s)}))⁻¹M^{(b)}x^{(b)}

subject to the constraints over continuous variables

G₁( ^{(s)})x^{(s)}=g₁( ^{(s)}),G₂( x^{(s)})x^{(s)}≦g₂(x^{(s)})

and the constraints over the discrete variables C^{(b)} (v^{(s)}), C^{(s)}(v^{(s)}). In the above, we have defined the (c₁^{(s)}+c₁^{(b)})×n_{c} and (c₂^{(s)}+c₂^{(b)})×n_{c} matrices G₁( ^{(s)} and G₂( ^{(s)}) by

$${G}_{1} ( {ϰ}^{( s )} ) = [ \begin{matrix}{G}_{1}^{( s )} ( {ϰ}^{( s )} ) \\ {G}_{1}^{( b )} ( {ϰ}^{( s )} )\end{matrix} ] , and {G}_{2} [ {ϰ}^{( s )} ) = [ \begin{matrix}{G}_{2}^{( s )} ( {ϰ}^{( s )} ) \\ {G}_{2}^{( b )} ( {ϰ}^{( s )} )\end{matrix} ] .$$

The (c₁^{(s)}+c₁^{(b)})- and (c₁^{(s)}+c₁^{(b)})-vectors g₁( ^{(s)}) and g₂( ^{(s)}) are defined by

$${g}_{1} ( {ϰ}^{( s )} ) = [ \begin{matrix}{g}_{1}^{( s )} ( {ϰ}^{( s )} ) \\ {g}_{1}^{( b )} ( {ϰ}^{( s )} )\end{matrix} ] , and {g}_{2} ( {ϰ}^{( s )} ) = [ \begin{matrix}{g}_{2}^{( s )} ( {ϰ}^{( s )} ) \\ {g}_{2}^{( b )} ( {ϰ}^{( s )} )\end{matrix} ] .$$

The optimization is accomplished by iterating two distinct phases. Phase one sets the continuous parameters optimally for a given setting of the discrete variables. We define the functions

d₁(x, )=(x−μ( ))^{t}C_{w}⁻¹( ))(x−μ( ))+R(r; ) and d₂( )=Z_{d}Z_{w}( ^{(s)},

The first phase of the optimization is the continuous problem:¹²

$${x}^{*} ( ϰ ) = {arg min}_{{x}^{( s )}} {d}_{1} ( {x}^{( s )} , ϰ ) subject to \\ {G}_{1} ( ϰ ) x = {g}_{1} ( ϰ ) and {G}_{2} ( ϰ ) x \leq {g}_{2} ( ϰ ) . \qquad ( 5 )$$

A detailed discussion on the solution of the phase 1 optimization problem is found in appendix D. The second phase determines the best value of the discrete variables by minimizing over a function of alone

$$\begin{matrix}{ϰ}^{*} = {arg min}_{ϰ} {d}_{1} ( x ( ϰ ) , ϰ ) + {d}_{2} ( ϰ ) subject to & ( 6 ) \\ {C}^{( b )} ( ϰ ) ⋀ {C}^{( s )} ( ϰ ) . & \end{matrix}$$

Further details on the phase 2 optimization are given in Appendix E. Once * has been determined, we find x* as x*=x( *). ¹²No optimization is required over range variables, since these are specified up front by both buyer and seller and merely add to the total distance.

6.1.7 Aggregation

Often a buyer may be willing to divide an order between multiple suppliers in order to aggregate the required demand or to obtain better deals. In this section, we detail how the present invention supports this aggregate optimization.

Aggregation can only occur over the continuous variables where values may be subdivided. Each continuous variable xᵢ must be parcelled out amongst a set of suppliers. Consequently, we extend our notation to xᵢ→\overline{x}_{i,k} giving the contribution of the kth supplier to continuous dimension i. The kth supplier may come from a (perhaps proper) subset of all suppliers. We indicate the set of potentially contributing suppliers as IC and the number of potentially contributing suppliers as |κ≡.¹³ ¹³All work to this point is thus seen as the special case |κ|=1.

We restrict the discrete variables to be the same across all potentially aggregated suppliers, i.e., we do not generalize ᵢ→ _{i,k}. This simplifying assumption is made for two reasons. First, the size of the discrete optimization problem is smaller and so optimization be performed faster. Second, it may be difficult to elicit from the buyer the allowed discrete alternatives for each supplier. Nevertheless, this generalization is straightforward should the need arise. This simplifying assumption requires that the union of discrete supplier constraints C_{κ}( )≡Λ_{kεκ}Cₖ^{(s)} ( ) yields a feasible solution when combined with the buyer's discrete constraints C^{(b)} ( ). A necessary (but not sufficient) condition for satisfaction is then that each constraint satisfaction problem k having constraints C^{(b)} ( ) Λ Cₖ^{(s)} ( ) has a feasible solution.¹⁴ Henceforth, we will assume that the set of suppliers, κ, satisfies this condition. If not, those suppliers ¹⁴It is easily seen this requirement is not sufficient by having C^{(b)}={( ₁, 1), ( ₁, 2)}, C₁^{(s)}={( ₁, 1)}, and C₂^{(s)}={( ₁, 2)}. violating the constraints C^{(b)} ( ) Λ Cₖ^{(s)} ( ) are eliminated from consideration in κ.

Discrete Search

We must search over the subsets of κ for feasible solutions, which is a combinatorial problem. Fortunately, given a complete labelling of variables, determining the largest subset is easy. For any given labelling of all discrete variables, if each C^{(b)} Λ Cₖ^{(s)} ∀ k Σ ⊂ κ is satisfiable, then the union C^{(b)} Λ C^{(s)} where Cₖ^{(s)}=Λ_{kεk} Cₖ^{(s)} is also satisfiable under the same labelling. The largest subset of variables is found by adding all k which have feasible solutions with the buyer. We needn't worry about smaller subsets because the continuous optimization will assign zero values to those if appropriate. Consequently, for any given labelling we let κ( ) represent the maximal subset of suppliers for which C^{(b)} ( ) Λ C_{κ}( ) is satisfiable. It is this set of suppliers which enter into the continuous optimization. The number of participating suppliers is denoted by |κ( )|.

Continuous Optimization

Optimization over the continuous variables is carried for each labelling . Generally speaking, the buyer's utility will not be an explicit function of x_{i,k} but only of xᵢ. We assume a linear relationship between these two quantities so that¹⁵

x=Ξ\overline{x}.

The n_{c}|κ( )| vector \tilde{x} is defined as \tilde{x}^{t}=[\tilde{x}₁, . . . , \tilde{x}ₙ_{_{c}}] where \tilde{x}ᵢ^{t}=[\tilde{x}_{i,1}, . . . , \tilde{x}_{i;|κ( )|}]. The n_{c}×n_{c}|κ( )| matrix Ξ ξ_{i,k} is assumed known and typically has the form¹⁶

$$Ξ = [ \begin{matrix}{ξ}_{1}^{t} & {0}^{t} & ⋯ & {0}^{t} \\ {0}^{t} & {ξ}_{2}^{t} & ⋯ & {0}^{t} \\ ⋮ & ⋮ & ⋰ & ⋮ \\ {0}^{t} & {0}^{t} & ⋯ & {ξ}_{{n}_{c}}^{t}\end{matrix} ]$$

where 0 is the K-vector of all zeros and ξᵢ is the linear combination relating xᵢ to the \tilde{x}_{i,k}. Under our assumptions for Ξ, xᵢ=ξᵢ^{t}\tilde{x}ᵢ. In cases where the buyer wants to accumulate the results from suppliers (e.g., aggregating quantities) ξ=1 is the |κ( )|-vector of all 1 s. In other cases the buyer may take ξ=1/51 κ( )| so that the time of delivery becomes the average ¹⁵We can also relate x and \tilde{x} by x=Ξ\tilde{x}+ν for some constant vector ν, which will not cause any complications. However, there seems to be little practical reason to do so. ¹⁶With no additional computational complexity, we can allow Ξ depend on . time of delivery across the suppliers. Constraints on x become constraints on \tilde{x} via

\tilde{G}₁( )\tilde{x}=g₁( ) and \tilde{G}₂( )\tilde{x}≦g₂( ) (7)

where \tilde{G}₁( )=\tilde{G}₁( ) and \tilde{G}₁( )=\tilde{G}₁Ξ. We might also expect the buyer to add additional linear constraints, such as requiring the latest shipment from any supplier to arrive earlier than a certain date, or requiring all deliveries to arrive the same day. There can also be constraints specific to particular suppliers, e.g., the buyer doesn't want any more than 100 units from supplier 5. These can be handled simply as constraints on the individual \tilde{x}_{i;k} and added as extra rows to \tilde{G}₁( ), \tilde{G}₂( ), \tilde{g}₁( ), and \tilde{g}₂( ). With aggregation, the quadratic form to be minimized is (Ξ\tilde{x}−μ( ))^{t}C_{w}⁻¹( )(Ξ\tilde{x}−μ( )) subject to the constraints given in Eq. (7). This minimization can be carried out through a straightforward generalization of the method given in Appendix D.

6.2 Implementation

In this section we outline an implementation of the entire e-procurement invention. We begin with a high-level description of the architecture, then fill in the details by describing a complete object model.

6.2.1 High-level Architecture of the Invention

There are at least two modes in which the invention may be used. First, the invention may reside at the site of large buyers, and suppliers who wish to sell to the buyer may be required to submit their capabilities via a web interface to the buyer. The invention may also be used within a marketplace hosted by a third party. Buyers/sellers log onto the market, submit their preference/capabilities, and act on the results. The architecture is modular enough to support both modes of operation.

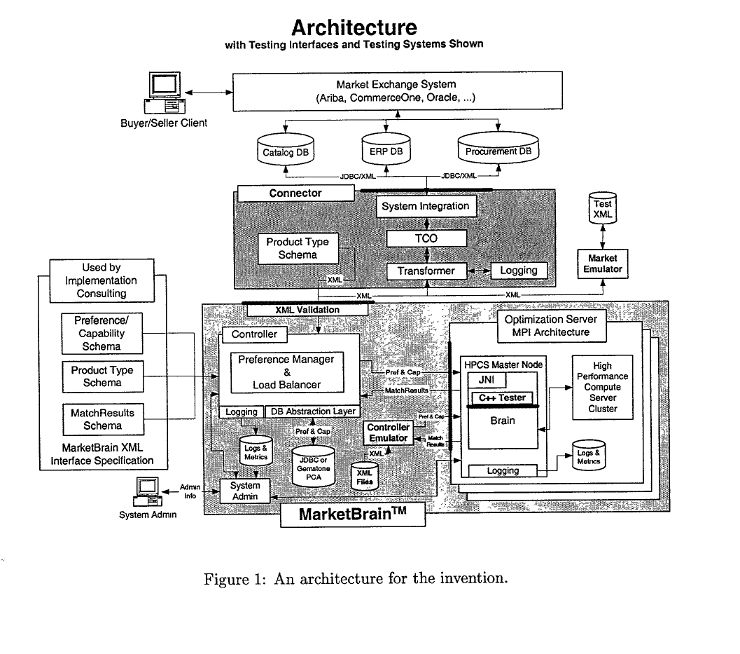

In FIG. 1 we present an architecture for the invention. We describe the architecture, starting from the optimization algorithm which finds matches between buyers and sellers and work our way outwards.

A controller surrounds the optimization engine, feeding it buyer preferences and seller capabilities. If multiple optimization processes are running (perhaps on different machines), the controller can also do load balancing, forwarding the request to the least busy process. The controller decomposes preferences and capabilities into their constituent buyer- and seller-specific versions (see below), selects the most specific matching preference/capability pairs, and sends them to the matching engine for optimization. The controller then collects responses from the matching engine and returns them to the buyer. Additionally, the controller logs all results into a database for recording purposes.

Another layer, called the Connector in FIG. 1, separates the graphical user interface (GUI) through which users communicate with the tool from the controller. This layer serves a number of functions. The connector transforms the description of preferences and capabilities from the GUI into a form suitable for the implementation of the matching engine. Part of this transformation involves validation of appropriate input from the GUI layer so that no malformed input is ever sent to the controller. The Connector layer can also pull data from ERP or SCM systems and automatically infer preferences (using the total cost of ownership function) for the buyer. The enterprise abstraction layer insulates the Connector from the precise details of the manner in which the ERP and SCM data needs to be gathered. Total cost of ownership is evaluated in the simulation modules, which may either be running locally at the client's site or running centrally at the main server. These simulation modules pull operational data (the vector β)from the enterprise abstraction layer. A preference optimization module (TCO) minimizes the total cost of ownership to determine the ideal trade and the flexibilities around the ideal trade.

At the outmost level, a layer provides integration with the GUI and/or host system. A number of administrative systems are expected at this layer. Market administration services allow easy definition of trading spaces, the dimensions of negotiation, limits on continuous variables, allowed settings of the discrete variables, etc. User administration services allow an administrator to define buyers, passwords, spending limits, etc. Supplier services accomplish similar tasks on the supply side. Managers for preferences, capabilities, and match results ensure that these objects are properly stored in a database. This layer layer also dynamically generates the html necessary for presentation of the data via a web interface to buyers and sellers.

For maximal portability, communications between the View and Connector are via XML documents. For maximal efficiency, communications between the Connector and matching controller are as serialized Java objects.

6.2.2 An Object Model for the Invention

The fundamental objects required for the invention are preferences from buyers, capabilities from sellers, and match results returned to all parties. The components of such objects have already been considered from a mathematical point of view, and we now describe one possible computer representation.

In this section we describe a complete grammar for the object model. The following syntactic conventions are used:

(nt) denotes a non-terminal symbol nt

[obj] denotes an optional grammar segment obj

{obj} denotes 1, or many times the grammar segment obj

→ denotes a production rule for non-terminal symbol. If there are multiple rules, say (a), (b), and (c), then these are denoted as

(nt)→(a)|(b)|(c).

In contrast, a production rule of the form

(nt)→(a),(b),(c)

indicates that the non-terminal (nt) is composed of three grammar segments, (a), (b), and (c)

terminal keywords are in serif font

Obvious non-terminal grammar elements like (string) and (integer) are not described.

Supply Side

To represent capabilities that apply to a specific buyer (perhaps for contractual reasons), we have defined a capability to be a list of (buyerSpecificCapability). With one exception, a buyer-specific capability applies only to one buyer—that buyer associated in the id field of the (buyerSpecificCapability). The exception occurs if the id field is * or wildcard. This indicates that the capability applies to all buyers. Using buyer-specific capabilities, suppliers can represent specific capabilities to certain buyers and generic capabilities applying to all other buyers. By not including a wildcard (buyerSpecificCapability) and only listing (buyerSpecificCapability)s applicable to specific buyers, sellers can also represent the fact that they will trade only with a subset of all buyers. In cases where both the wildcard (buyerSpecificCapability) and a (buyerSpecificCapability) applicable to a specific buyer apply, the most specific (buyerSpecificCapability) is selected.

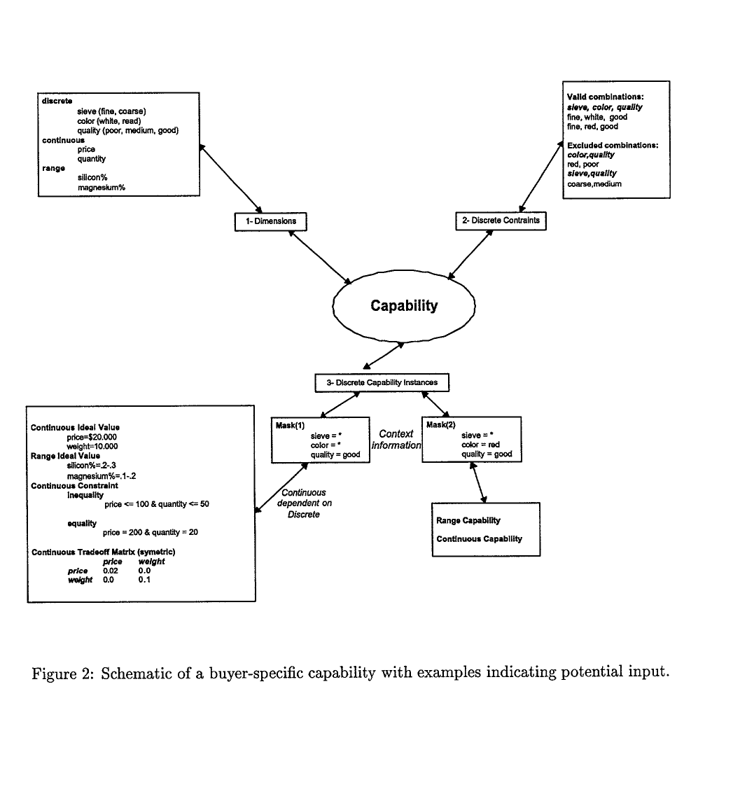

A schematic of a (sellerSpecificPreference) is given in FIG. 2.

We begin at the top level of a capability:

capability→{(buyerSpecificCapability)}

where

(buyerSpecificCapability)→id: (id),

discrete: {(discreteVarDescription)},

continuous: {(continuousVarDescription)},

range: {(rangeVarDescription)},

[discreteConstraint: (discreteConstraint)],

instance: {(discreteCapabilityInstance)}

[aggregation Participation: 0|1].

(id) identifies a buyer or group of buyers. Individual buyers are represented by some unique identifier (say an integer) and the group of all buyers is identified by the wildcard character ‘*’. So we have

(id)→(integer)|*.

aggregationParticipation is a Boolean flag giving the supplier's willingness to participate in aggregate orders to the identified buyer.

Each of the variable constituent components is described by

(discreteVarDescription)→name: (integer),

allowedValues: {(integer)}

(continuousVarDescription)→name: (integer),

min: (double),

max: (double)

(rangeVarDescription)→name: (integer).

In its simplest form, a (discreteConstraint) is a list of more primitive constraints

(discreteConstraint)→{(primitiveDiscreteConstraint)}

where each primitive constraint is composed as follows:

(primitiveDiscreteConstraint)→name: (string)

variables: {(discreteVarName)},

includes: 0|1,

values: (integerMatrix)

(discreteVarName) is the name of the discrete variable involved in the constraint

(discreteVarName)→(integer).

The includes field is a bit. If the bit is 1, then the combinations listed in the values field are the allowed values the variables may take on. If the bit is 0, then the combinations listed in values are the excluded combinations, i.e., everything in the powerset of the variables is allowed except those combinations listed in values. The order of the variable names is significant, since they will be assumed to be in the same order in values. If there are a variables involved in the constraint, and c constraints, then (integerMatrix) is an a x c matrix of integers:

(integerMatrix)→(integerVector), . . . , (integerVector)

(integerVector)→(integer), . . . , (integer)

The (discreteCapabilityInstance) component is described by

(discreteCapabilityInstance)→mask: (discreteVarMask),

[rangeCapability: {(rangeVarInstance) }],

continuousCapability: (continuousCapability)

continuousConstraints: (continuousConstraints)

A (rangevarInstance) defines a range variable and has the form

(rangeVarInstance)→name: (integer),

min: (double),

max: (double).

The (discreteVarMask) relates to the discussion of 6.2.2. As in Table 3 we have

(discreteVarMask)→{ (extendedVarValue) }

where an (extendedVarValue) is either an integer from the domain of the discrete variable or the wildcard character ‘*’:

(extendedVarValue)→(integer)|*.

(continuousConstraints) describes the hard linear constraints for the continuous variables. Since these constraints may be either inequality or equality, we have

(continuousConstraints)→[equality: (linearConstraints)],

[inequality: (linearConstraints)]

Both the equality and inequality constraints are expressed through a matrix which is c×n_{c} where c is the number of constraints, and a vector which is c×1. Consequently we have

(linearConstraints)→matrix: (doubleMatrix),

vector: (doubleVector)

A (doubleMatrix) is defined by

(doubleMatrix)→(doubleVector), . . . , (doubleVector)

and a (doubleVector) is just what the name suggests—a vector of doubles:

(doubleVector)→(double), . . . , (double).

The only remaining undescribed element above is (continuousCapability) whose description is

(continuousCapability)→breakPoints: (doubleListMatrix), valAtBreakPoints: (doubleListMatrix)

(doubleListMatrix) describes a n_{c}×n_{c}, matrix whose elements are lists of (double):

(doubleListMatrix)→(doubleListVector), . . . , (doubleListVector)

(doubleListVector)→(doubleList), . . . , (doubleList)

(doubleList)→{(double)}

It is assumed that the rows and columns of the matrix are in some canonical order so that we know which continuous variable is referenced. A natural order is the one defined in {(continuousVarDescription) }

Preferences

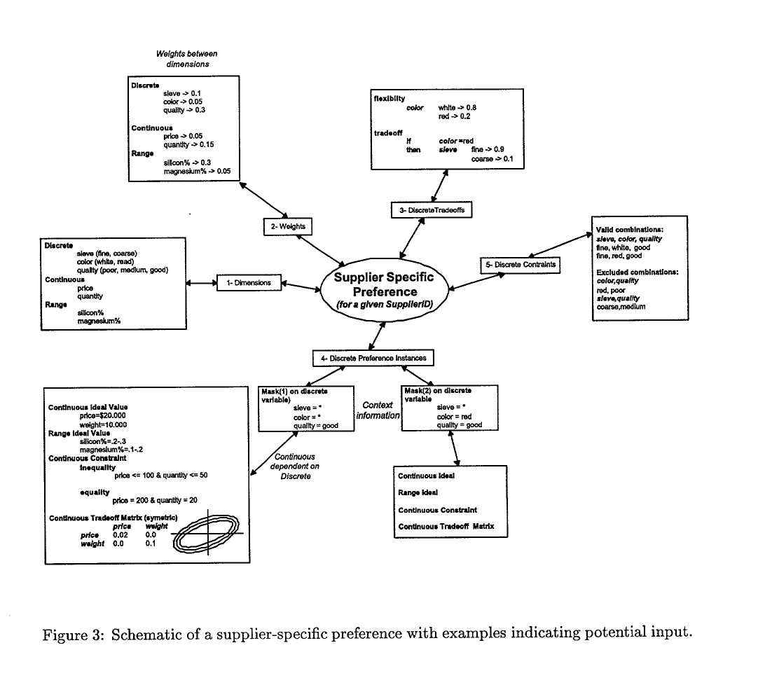

Just as capabilities may be buyer-specific so too may preferences be seller-specific. The same rules determining which seller-specific preference to apply are followed. A schematic of a (sellerSpecificPreference) is given in FIG. 3.

We define a preference as follows

(preference)→{(sellerSpecificPreference)}[, (aggregatedPreference)]

i.e., a preference is a list of (sellerSpecificPreference) with an optional aggregated preference. We first describe (sellerSpecificPreference) and then consider (aggregatedPreference).

The (sellerSpecificPreference) is composed as follows

(sellerSpecificPreference)→4id: (id),

discrete: {(discreteVarDescription) },

continuous: {(continuousVarDescription) },

range: {(rangeVarDescription)},

dimensionWeights: (dimensionWeights),

discreteTradeoff: (tradeoffTables)

[discreteConstraint: (discreteConstraint)],

instance: {(discretePreferenceInstance)}

Of these elements, only (dimensionWeights), (tradeoffTables), and (discretePreferenceInstance) have yet to be defined. (dimensionWeights) gives the weights of all dimensions that indicate their importance. For convenience we break up the weights according to the three types of variables. Thus we have

(dimensionWeights)→range: (doubleVector),

discrete: (doubleVector),

continuous: (doubleVector)

A (doubleVector) has been described previously. Each of the corresponding vectors is as long as the number of range, discrete, or continuous dimensions. (tradeoffTables) is an n_{discrete}×n_{discrete} matrix of (tradeoffTable):

(tradeoffTables)→(tradeoffTableMatrix)

(tradeoffTableMatrix)→(tradeoffTableVector), . . . , (tradeoffTableVector)

(tradeoffTableVector)→(tradeoffTable), . . . , (tradeoffTable)

A (tradeoffTable) is simply a matrix of double values.

Finally, we turn to the last undefined component of a (preference). A (discretePreferenceInstance) is composed as follows:

(discretePreferenceInstance)→mask: (mask),

[rangeIdeal: {(rangeVarInstance)],

continuousIdeal: (doubleVector),

tradeoffMatrix: (doubleMatrix),

[continuousConstraints: (continuousConstraints)]

The rangeIdeal and continuousIdeal fields give the desired range and continuous trade parameters. The tradeoffMatrix field gives the positive definite matrix expressing the tradeoffs amongst the continuous variables. (continuousConstraints) have been described previously in the sell-side specification.

To complete the specification of preferences, we conclude with the definition of (aggregatedPreference) Refer to the discussion of section 6.1.7 for details.

(aggregatedPreference)→participants: {(aggSpecification)},

contributionType: (contributionTypeVector),

additionalConstraints: (continuousConstraints),

discrete: {(discreteVarDescription)},

continuous: {(continuousVarDescription) },

range: {(rangeVarDescription) },

dimensionWeights: (dimensionWeights),

discreteTradeoff: (tradeoffTables)

[discreteConstraint: (discreteConstraint)],

instance: {(discretePreferenceInstance) }

In the above definition, the previously defined elements maintain their meaning. The additionalConstraints field allows the buyer to express constraints around the aggregation, such as “all orders must arrive on the same day,” etc. participants lists the suppliers who can participate in the aggregation and their characteristics. Note that if the wildcard supplier participates, the order can potentially be aggregated across all suppliers. (aggSpecification)

TABLE 3
Example of discrete masks for specifying continuous and range variables
which are dependent on discrete variables. κ₁ and κ₃ signify specific
values for the first and third discrete variables. The specificity of each
mask is indicated in the third column.

| discrete mask | output | specificity |
|---|---|---|
| [* * *] | {continuous1, range1} | 0 |
| [κ₁ * *] | {continuous2, range2} | 1 |
| [κ₁ * κ₃] | {continuous3, range3} | 2 |

describes information specific to a supplier participating in the aggregation. It is defined by

(aggSpecification)→id: (id).

id identifies the participating supplier and constraints specific to that supplier defined in an accompanying (sellerSpecificPreference) will be used in the optimization. Additional information may be added as required. The contributionType field is used to define the ξ vectors used in aggregation. The (contributionTypeVector) consists of n_{c} elements indicating the type of aggregation for each continuous dimension:

(contributionTypeVector)→(contributionType), . . . , (contributionType).

Possible contribution types include

(contributionType)→sum, average, zero.

sum sets ξ=1, average sets ξ=1/|κ( )|, and zero sets ξ=0.

Masking

We have allowed constraints, ideal values, tradeoffs, and continuous capabilities to be dependent on discrete variables. In this section we describe an efficient manner in which to encode this dependence.

The data structure must represent continuous and range variables for all valid discrete inputs. An efficient way to do this is to use hierarchical definitions. At the top of the hierarchy are the definitions of the continuous and range variables for the discrete values ^{t}=[*, . . . , *]. These values apply to all θ unless more specialized masks are defined. A more specialized mask of the continuous and range variables is specified by defining values for some of the components ᵢ. The more components that are defined, the more specialized the definition. The most specific mask is always used. An example definition for three discrete variables is given in Table 3. The response to the lookup [~₁ \tilde{x}₂ \tilde{x}₃] is {continuous3, range3} if and only if ₁=~₁Λ ₃=~₃,{continuous2, range2} if and only if ₁=~₁Λ ₃≢~₃, and {continuous1, range1} otherwise.

Match Results

Returned to the buyer is a list of matches with different suppliers, which can be ranked and viewed in many different ways in the GUI. A (matchResultList) is a list of matchResult:

(matchResultList)→{f(matchResult)}.

A match result may either be a (singleSupplierMatchResult) or an (aggregatedMatchResult):

(matchResult)→(singleSupplierMatchResult)|(aggregatedMatchResult).

A (singleSupplierMatchResult) represents the best trade with a single supplier and is composed of the following elements:

(singleSupplierMatchResult) supplierId: (integer),

utility: (double),

feasible: 0|1,

[costFactors: {(double)],

continuous: {(double)},

discrete: {(discreteVarDescription) },

range: (rangeVarInstance).

The supplierId indicates the supplier sourcing this trade and the utility field indicates the utility of the trade (which can be used to rank the trades). feasible is a bit indicating whether or not a feasible trade with this supplier was found. The continuous, discrete, and range fields list the respective trade parameters determined by the matching algorithm. The optional cost factors field lists the constituent costs contributing to the total cost of ownership C₀ evaluated at the trade point returned in the (singleSupplierMatchResult).

An (aggregatedMatchResult) returns the optimal trade when the buyer has requested aggregation. It is composed of the following elements:

(aggregatedMatchResult)→utility: (double),

feasible: 0|1,

2[costFactors: {(double)],

supplierTradeParameters: {(supplierTradeParameters) }.

As before, the utility field gives the utility of the aggregate trade, and the feasibility flag indicates whether or not a feasible aggregate trade was found (there may not be if the constraints were too stringent). costFactors can also be returned in C₀ is sufficiently general to handle aggregated trades. Finally, (supplierTradeParameters) lists the trade parameters for each supplier involved in the aggregation. It is defined as follows:

(supplierTradeParameters)→supplierId (integer),

continuous: {(double)},

discrete: {(discreteVarDescription) },

range: (rangeVarInstance).

6.3 Summary

We have described an efficient computational procedure in which to encode buyer's trading preferences and hard constraints, supplier's delivery capabilities and constraints, and optimize to find those matches between one buyer and one or many sellers that maximize the buyer's utility. By optimizing against both qualitative and quantitative factors, and exploiting the trading flexibilities possessed by both parties, the system determines better trades. The tool is particularly useful as companies move their direct material purchasing online. By optimizing across flexibilities, win-win trades are discovered for both trading parties.

The representation of trading preferences is designed to be expressive yet easily elicitable from a buyer, and computationally tractable. The representation of supplier capabilities was chosen to parallel the manner in which suppliers already think of their delivery capabilities and seamlessly includes volume discounts and incremental costs. These supplier capabilities may be part of an online catalog. The representation of the negotiation space is rich, supporting three types of variables.

We have outlined a manner in which preferences may be inferred automatically through models of the purchasing company. Such models incorporate many cost factors, taking the total cost of ownership into account. The system provides trades which minimize the total cost and represent significant new savings.

The invention can operate both at a buyer's site, where suppliers input their capabilities through an HTML interface to the world wide web or as an embedded part of an electronic market hosted by a particular web site. The invention may operate at regularly scheduled intervals or sporadically in lieu of current request for quotations (RFQ). The buyer may broadcast a RFQ event to suppliers, indicating a time within which suppliers must respond. At the close of the event, the buyer can use the present invention to assist in the analysis of the supplier responses.

Complex algorithms have been specified which should permit most matching optimization to occur in near real-time. The rapidity of optimization, combined with graphical what-if tools, allows for analysis and exploration of trades, which should significantly improve the quality of purchasing decisions.

6.4 An e-Commerce Infrastructure for Value Chains

In this section we describe in detail how the proposed infrastructure delivers on the promises made in the Summary of the Invention. We begin by describing major innovations in the present invention and how they are all used synergistically.

6.4.1 Major Innovations

The most broad invention combines at least four advances:

1. multidimensional automated markets (hereafter simply markets) which capture many aspects of value.

2. algorithms and interfaces which implicitly allow for consumers to express the preferences over the multiple dimensions of value

3. linked markets allowing for complex assembly of products

4. specification of the constraints (both logical and numerical) inherent between markets to allow for coordinated buys and sells between markets

In addition, inventions described in a patent application titled, “An Adaptive and Reliable System and Method for Operations Management”, application Ser. No. 09/345,441 filed Jul. 1, 1999 (the contents of which are herein incorporated by reference) can also be used in conjunction with the present invention. These other inventions are:

5. the use of models and optimization algorithms to optimally determine the best bids to submit to the automated market

6. the use of subset relations is-a, has-a etc. to automatically construct the constraints between markets

6.4.2 Integrated Picture

The internet and e-commerce are changing the way consumers and businesses trade with each other. One interesting trend is the development of centralized economic hubs (e.g. eSteel, ChemDex) through which all e-commerce in a particular domain flows. This trend is expected to continue and become more prevalent. The invention described here is the tool that drives these economic hubs.

Before describing the components and innovations in detail we describe the overall architecture of the integrated system. For concreteness we focus on the invention as applied to the personal computer (PC) supply chain. We note that the ideas can be applied equally well to supply chains in other industries.

The infrastructure is composed of three major components all running on different computers. A central server (or more likely servers) coupled to the economic hub serves as the source of consumer demand. Other sets of servers act as the trading markets themselves relaying information between buyers and sellers. Finally, running at each market participant's site is client software coupled to the relevant markets.

Consumer Demand: Consumer demand is pulled through the supply chain through a set of coupled reverse auction¹⁷ markets. An interface iteratively elicits multi-dimensional consumer preferences which is then forwarded to a top level market where suppliers offer to fulfill the consumer request. The functioning of the consumer interface is described in more detail in section 6.4.3. ¹⁷A reverse auction is like an auction except that a request is broadcast to suppliers who bid on fulfilling the request. Unlike traditional auctions the proposed market clears in one shot, i.e. each supplier has only one chance to bid.

Markets: Markets within the supply chain are represented by servers which link trading partners. The market broadcasts demand, collects responses, and forwards results back to the source of the demand. See section 6.4.4 for more information on the functioning of markets, particularly the coupling between markets.

Client Companies: Each trading participant (whether buying or selling) is represented by client software connected to the appropriate markets. The client software both initiates requests and responds to requests from other market participants. The client software running at the company also maintains a memory of all past transactions and can eliminate those that are out of date. A user interface allows companies to define the operation of their interface to the markets. See 6.4.5 for further details.

Supplier Push As has been mentioned the infrastructure is organized around demand pulled through the supply chain by the consumer. Interestingly, the same pull infrastructure can also be used by suppliers to push demand. In addition to requesting and responding to requests, the market interface running locally at company sites could also be used to advertise capability (capability not in response to any particular demand) to the market which will then forward the advertised capability to any participant connected to the market.

6.4.3 Climbing in Preference Space: the consumer interface

The consumer drives the integrated infrastructure by generating demand. In our example, a graphical user interface (GUI) at the PC economic hub provides a centralized interface through which all computers are purchased. The GUI provides a number of advantages to both consumers and computer vendors. A computer is described across multiple dimensions of value. Some of these dimensions include: price, memory size, processor speed, hard drive side, removable storage, monitor size and resolution, financing, warranty, delivery date, etc. For each dimension the user can identify a preference. For example the consumer may wish 128 Mb of memory, a 600 MHz Pentium III processor with a 15 Gb hard drive for $1500 delivered within 3 weeks. Additionally, it may be important for the consumer to express constraints that must be satisfied. To keep things as simple as possible we express an optional inequality constraint for each dimension, e.g. price must be less than $1600 and the hard drive must be at least 12 Gb.

Optional Dimensions: This example brings up an interesting feature of the dimensions of value. Imagine for a moment that one of the dimensions was portability with possible values being high portability, medium portability, and low portability. In each of these cases we might consider lightweight laptops, heavy laptops, and desktops. Any one of these choices might then invoke additional situational dimensions. For example, if we select high portability then battery life (in hours) becomes an important dimension which is only applicable to laptops. There are a number of ways to treat these optional dimensions. The simplest possibility is to have separate markets for laptops and desktops with appropriate dimensions for each. A better solution is to have a GUI which only turns on the optional dimensions when appropriate. If low portability is selected by the user the battery life dimension remains lightly greyed out and inaccessible. If medium or high portability is required then the battery life dimension is activated. In the technical details section we show how this can easily be accomplished.

Dimension Weighting: Optionally, the user may also specify an importance to each dimension. If hard drive size and price are paramount these two dimensions have high value while all other dimensions have low value. The weighting is used to identify similarity between computers; two computers which are quite different only in one dimension which is not highly weighted by the consumer are considered quite similar. See the technical details section.

Threshold Constraints: A final way in which consumers may specify their needs is through constraints expressed for each dimension. The constraints are simple to state. The consumer specifies a threshold and whether or not he wants to be above or below that threshold. For example the consumer may specify that the monitor size has to be at least 17 inches and he will not pay any more than $1500. Knowledgeable consumers may define all these settings directly or the software may infer settings for less experienced consumers based upon simple questions (like the major uses of the computer).

Branding: Consumers may also have brand preferences for a computer or any of its components. The proposed GUI allows for users to express these preferences. There are two alternative ways in which branding might work and depending on the application either may be appropriate. In the first alternative brand name is a hard constraint and no computers are shown to the consumer unless the brand name matches the consumers desire. In the second alternative brand name is a soft constraint and the consumer merely prefers one brand over another.

In either case the GUI allows the user to specify for each dimension whether or not brand matters and if so which brand/brands is/are preferred.18 If brand is a hard constraint this constraint is propagated to the top level market and all suppliers of the top level market so that no responses not respecting the constraint are ever returned to the consumer. If brand is a soft constraint it is incorporated into the distance function dᵢ as described in the technical details section. Otherwise identical components which match the desired brand are closer than those components which do not match the desired brand. ¹⁸We might also allow consumers to rank their brand preferences but this extension seems unnecessary in light of the iterative nature of product exploration.

Iterative Hillclimbing and Recombination: Once the consumer has specified a desired computer defined as a point (and perhaps weights and constraints) in the high dimensional value space, a query is sent to a top-level automated market. Sellers of computers (e.g. Micron, Gateway, Dell) attached to the market respond to the consumer request by returning offers (one or many) to the market for candidate computers again represented in the high-dimensional space of value. Responses to the consumer are filtered to satisfy the specified constraints. The GUI allows the consumer to sort responses based on any of the dimensions (see the dᵢ function in the technical details section) or according to a global measure of distance between two computers (see the d function in the technical details section).

The consumer may modify any of the responses (a mutation) and use this as a resubmission to the market. This method of exploring the space of possible computers according to the consumer's desires and the supplier's availability can broadly be summarized as climbing in preference space. The climbing can begin from the most recently visited computer configuration or from any configuration that has been saved in a history list.¹⁹ It is also perfectly feasible to allow the consumer to recombine desirable computer configurations. For example the user may ask for configurations which are “sin between” two previously examined configurations and combine the advantages of both configurations. We also might allow the consumer to submit more than a single configuration to the top level market and receive responses around all submissions. ¹⁹History lists extend both within and between sessions.

Benefits of the Approach: This procedure offers a significant benefit over other approaches to multidimensional markets. In systems like OptiMark^{°}the consumer (in this case a financial trader) must a priori specify preferences over all dimensions (price and quantity). The explicit specification of preference over even two dimensions is a difficult task and it is unreasonable to expect consumers to be able to do this. The present innovation allows consumers to iteratively explore preference space thereby implicitly defining preference in a friendly manner. ²⁰U.S. Pat. No. 5,845,266, “Crossing network utilizing satisfaction density profile with price discovery features” dated Dec. 1, 1998.

This method of interactive consumer exploration is suitable for any complex product and we expect the application to be broad. The present invention has many other applications²¹ ²¹e.g. credit cards where the dimensions might be interest rate, yearly fee, grace period, benefits (like frequent flyer miles, etc.)

Technical Details We have mentioned that computer configurations can be sorted on all dimensions according to how closely they match the consumers preferences. In this section we describe how this sorting might work and how it interacts with the weights and brand preferences attached to each dimension.

The value space defines a notion of distance or similarity between products (in this case computers) defined as follows: If there are a total of D dimensions²² of value then a computer c is described as a D-vector of the settings for each dimension. Let i label the components of c so that for example c₁=memory is C₂=processor speed etc. For example, the memory dimension might assume any of the values c₁=64 Mb, c₁=128 Mb, or c₁=256 Mb and similarly for all other dimensions. Let αᵢ be a binary variable (i.e. aᵢ takes the value 0 or 1) indicating which dimensions are actually used. If cⱼ is the dimension corresponding to battery life in hours then aⱼ=1 indicates this dimension is appropriate while aⱼ=0 indicates the dimension is not appropriate. The vector whose components are the αᵢ is represented by a. ²² The D dimensions include both required and optional dimensions.

A consumer preference also includes optional weights and preferred brand. The weight (or importance) of dimension i is indicated by wᵢ. All wᵢ are non-negative and normalized so that Σᵢ₌₁^{D}aᵢwᵢ1. The vector of all weights is represented by w. The brand preferences for dimension i are expressed as a (possibly empty) set Bᵢ which includes desired brands. B is the set of all Bᵢ. A complete consumer description is thus represented by the vector C={c, a, w, B} with components Cᵢ={cᵢ, aᵢ, wᵢ, Bᵢ}.

The distance d(c, c′) between computers c and c′ is then defined as

$$d ( C , {C}^{′} ) = \frac{{\sum }_{i = 1}^{D} {a}_{i} {w}_{i} {d}_{i} ( {C}_{i} , {C}_{i}^{′} )}{{\sum }_{i = 1}^{D} {a}_{i}} \qquad ( 8 )$$

where dᵢ(Cᵢ, Cᵢ′) measures the distance along the single dimension i. To allow for standard comparison between computer configurations we normalize all dᵢ so that they lie between 0 and 1.

We recall from previous discussion that for soft brand constraints the matching of a brand to its desired value is incorporated into the distance function. Thus we generally write the distance function dᵢ as the sum of two terms, one for brand and one for similarity. If bᵢ is an indicator variable whose value is 1 if the consumer has identified that brand matters for the ith dimension (i.e. Bᵢ is non-empty) and 0 otherwise, then we write

dᵢ(Cᵢ,C₁′)=aᵢbᵢdᵢ^{(b)}(Bᵢ,Bᵢ′)+(1−aᵢbᵢ)dᵢ^{(s)}(cᵢ,cᵢ′). (9)

The αᵢ parameter determines the relative importance between brand name and similarity. Lacking better information we might take all αᵢ=½.²³ ²³Better values for α, might be identified from real consumer interaction with the GUI.

For simplicity we assume that the brand distance function, dᵢ^{(b)}(cᵢ, cᵢ′), is 0 if there is overlap in the preferred brands for cᵢ and cᵢ′ and 1 otherwise, i.e.

$${d}_{i}^{( b )} ( {B}_{i} , {B}_{i}^{′} ) = \{ \begin{matrix}1 & if {B}_{i} ⋂ {B}_{i}^{′} = ∅ \\ 0 & otherwise\end{matrix} . \qquad ( 10 )$$

The similarity distance measure, dᵢ^{(s)}(cᵢ,cᵢ′), is only slightly more complicated. The allowed values for most dimensions are discrete over a finite range. If the ith dimension is bounded and ranges from cᵢ^{min} to cᵢ^{max} then we might define

$${d}_{i}^{( s )} ( {c}_{i} , {c}_{i}^{′} ) ≡ \frac{\vert {c}_{i} - {c}_{i}^{′} \vert}{{c}_{i}^{max} - {c}_{i}^{min}} \qquad ( 11 )$$

though other choices are certainly possible and may be more appropriate depending on the nature of the dimension. In many situations it is appropriate that the distance function is not symmetric, i.e. dᵢ^{(s)}(cᵢ′,cᵢ). Examples of asymmetry are easy to find. A consumer may be more than willing to accept an extra few Mb of memory but will be very dissatisfied receiving a few Mb less. As a concrete example we may offer open ended ranges on most choices. The range is defined by a single point xᵢ′ and an indication of whether the range is above or below that point. In the case of the range [xᵢ′, ∞) we can take the distance function measuring the distance from the range to be d(xᵢ, xᵢ′)=(xᵢ′−xᵢ)θ(xᵢ′−xᵢ). In the opposite case where the range is [0, xᵢ′] the distance function can be d(xᵢ, xᵢ′)θ(xᵢ−xᵢ′)θ(xᵢ−xᵢ′). Accordingly, the present invention also includes possibilities for dᵢ^{(s)}(cᵢ, dᵢ).

Distance Ranking: The distance metric of Eq. (8) allows for a global ranking (after configurations not satisfying the constraints have been filtered out) of vendor responses based upon their similarity to the original consumer request (smaller distances are more similar). If C_{req} describes the consumer specified computer and a labels responses from vendors in response to the request then the automated market sorts the responses based upon d(C_{req}, Cₐ) and returns a specified number back to the consumer interface. The interface also allows sorting (in order of decreasing distance) on each dimension according to the dᵢ. The consumer then iterates the process starting from any of the returned offers, modifying them slightly and re-submitting to the market. In this way the consumer can move about in the space of preferences climbing towards ever more desirable computer configurations. When the consumer finally does identify a configuration that he desires to purchase it is a simple matter of hitting a buy button.

6.4.4 Integrating the Supply Chain: cascading markets

It is natural to consider the extension of high-dimensional automated markets to other transactions made in the supply chain. In fact, this may be essential to fulfill the kind of real-time consumer preference exploration described in section 6.4.3. These other markets will also typically be high dimensional but the dimensions will differ from the top-level market. For example there may be a hard drive market where buyers of hard drives (whether computer vendors, consumers, or value added retailers) meet sellers (e.g. suppliers like Seagate, Western Digital). The dimensions of the hard drive market might include: price, size (in Gb), type (IDE vs SCSI), quantity, delivery date, etc.

Operation of Cascading Markets: The basic idea is straightforward. Before a computer vendor responds to consumer requests in the top-level market the vendor may send its own requests to submarkets to purchase products and services it needs to meet the consumer demand. Suppliers to the computer vendors may in turn go to other submarkets before responding to computer vendor requests. A single consumer request may then result in real-time cascading inquiries to a tree of nested markets all the way down to the beginning of the supply chain. We call the market which originated a request the parent market and the submarket a child market. It is a requirement that any possible path through the cascading markets is acyclic.

When the consumer moves on to examine a new configuration all relevant market participants (i.e. those that responded to the initial customer request or any concommittant subsequent request) are informed and their offers are released. If, on the other hand, the consumer elects to purchase the configuration all participants are informed and are held to their offers. When combined with emerging XML standards for e-commerce (e.g. RosettaNet in the IT industry) the necessary “paperwork” for confirmed purchases can be generated by the computer and sent between all relevant parties (including the consumer after a credit card check).

Note that it remains unlikely that every consumer purchase will trigger a cascade of transactions throughout the tree of markets because it is not profitable in most supply chains to order and transport in single unit batches. Thus, only when inventories need to be replenished will companies in the supply chain go to the automated market in response to a request.

Auxiliary Information: It is useful to pass additional information between markets beyond merely the parameters describing the trade. There are many reasons extra information may be desired and we describe two applications of auxiliary information. Most simply, in cases where it is important to identify who the buyer or seller actually are an additional identifier may be passed labeling each trader.

A more serious application addresses a potential problem of nested markets. A problem with cascading markets is that demand can spuriously be amplified as it moves between markets and away from its originating source. Consider a consumer demand for 100 computers. If two of the computer suppliers are both low on hard drives they might both submit a request to the hard drive market for an additional 100 drives. If the hard drive company were to estimate demand based solely upon the hard drive market then in this case the company would falsely assume that the demand was twice as high as it really is. This problem is easily fixed by supplying auxiliary information along with trade parameters. A request that comes into a toplevel market is assigned an identifier indicating the market and a unique identifier.²⁴ Every request to submarkets that is in response to a request in the parent market is again assigned both market and trade identifiers. These identifiers are appended to the identifiers from the parent market when the request is broadcast to all suppliers listening to the market. Returning to the hard drive example, if the top-level market has market identifier ASSEMBLE and the hard drive market has identifier HARDDRIVE and if the original consumer request had trade identifier 4561133 and the market trade identifiers were 56891 and 56892 respectively then the identifiers which are passed to all hard drive suppliers in response to both hard drive demands are ASSEMBLE:4561133,HARDDRIVE:56891 and ASSEMBLE:4561133,HARDDRIVE:56892 respectively. In this way all hard drive suppliers can see that the request originated with the same demand. In fact such mechanisms might also allow for improved forecasting of demand since all demand is accompanied by its path through the entire supply chain which may contain additional useful information. ²⁴All trades in that market will have distinct identifiers.

Expiration Dates: One of the advantages of the present e-commerce infrastructure is the real-time setting of trade parameters. Companies can use the system to optimize their operations continuously. To achieve the maximal benefit from continuous optimization it is important that the offers made by any market participant have a bounded lifetime. What is optimal now may not be in a day (or even an hour). Thus an additional application of auxiliary information is the inclusion of expiration dates after which the trader parameters are invalid. Unless perishable trades are executed before the expiration date they are removed from the system.

Other B2B Market Issues The cascading submarkets are all business to business markets and as such can operate under different rules than the business to consumer market. In this section we address what some of these differences might be.

Clearing Mechanisms: We have proposed that the B2B markets clear in a fashion similar to the B2C market. One important difference is that these markets probably must clear in one shot in order to deliver real-time feedback to the end consumer. There are certainly other ways in which the B2B markets clear. One possibility is to use optimization tools to define satisfaction surfaces just as in OptiMark. In this way the parameters of the trade are determined by software to optimize some joint criteria. Ideally, we would like protection for other B2B market clearing mechanisms.

Aggregation: Another potentially important function of automated markets is the aggregation of orders to meet demand. For large orders it may be the case that no single supplier can meet the requested demand. Market software can automatically collect responses to fulfill orders. This software, in addition to coordinating between purchases in different markets (see section 6.4.5) can also be used to coordinate multiple orders within the same market.

Many-to-many markets: Thus far the market mechanisms we have described all result in one-to-one trades (except if we aggregate orders in which case a trade may be many-to-one). For future reference we also note that the markets themselves may be more complex and used for many-to-many trades.

6.4.5 Coordination Between Markets: inter-market language

The assembly of a product or service from constituent products or services often requires coordinated purchases from a number of supply markets.

Logical Constraints: As illustration, there is no point in ordering a part if transportation can not also be arranged at the appropriate time. Both events must occur or else neither of the purchases should be made. This is an example of a Boolean logical constraint (in this case the logical and function) that exists between multiple markets. Of course in more complicated situations there may be more complex logical constraints between markets.

For added expressivity we propose using linear logic as the language in which to express logical constraints. Linear logic offers compelling advantages over Boolean logic since it subsumes Boolean logic and is resource sensitive exactly as real supply chain transactions are. Efficient implementations of linear logic exist so that checking of linear logical constraints is straightforward. The present invention includes support for both Boolean and linear logical constraints.

Numerical Constraints: There is another important class of relationships that may exist between markets. In most complex processes certain events have to occur sequentially; the process can not progress until some condition is fulfilled. Our shipping example also provides an example of this. There is no point arranging the purchase of transportation if the only available pick up date is before the item to be shipped can be completed. This is an example of a numerical constraint that exists between the parameters of transactions on different markets and optionally some description of the state of the company. Other examples might include cost constraints which require that the total expenditures on all purchases to be less than some threshold.

A Constraint Language: Any automated market solution to supply chain coordination problems will require these constraint mechanisms and generically these constraints will be either logical (as in the and constraint) or numerical (as in the cost constraint). We propose an Inter-Market Language (IML) in which to express these constraints so that the nested market solution always respects the user specified constraints.

IML constraints are specified as follows. Let mi be a logical variable which is true if a transaction is made on the ith market (and false otherwise) and let mᵢ(xᵢ) be a logical variable which is true if the transaction occurs with multidimensional parameters xᵢ.²⁵ Furthermore let s be a vector of numerical values (for example describing current inventory levels, lead times, etc) and \tilde{s} be a vector of logical values describing the state of the company. The two classes of IML constraints which both must simultaneously be satisfied are then expressed as

B(m₁, . . . ,m_{M},) (12)

N=(x₁, . . . ,x_{M},s)=0,N<(x₁, . . . ,x_{M},s)<0 (13)

where B(•) is an arbitrary logical function, there are M relevant submarkets, and the functions N=(•) 0 and N<(•)<0 express the equality and inequality constraints respectively. ²⁵m, and mᵢ(xᵢ) are related by mᵢ=Vₓmᵢ(x) where by Vₓ_{ᵢ} we mean the logical or of mᵢ(xᵢ) over all possible values of the parameters x₁.

Operational Use of Constraints: Operationally the coordination amongst different market transactions is achieved as follows. Software representing the interests of a vendor (and therefore probably running at the vendors site) expressed in IML listens to servers representing various markets. When a market request that the vendor wishes to respond to is heard the software examines the companies internal state is, {s,\tilde{S}} and determines what items, if any, need to be purchased on child submarkets. The software defines the purchase by defining a point or the desired parameters for each trade in each market. These requests are sent to servers representing each child market. The client software running at each company then waits for responses from each child market. If there are M total markets queried and nᵢ responses from the ith market then there are a total of Πᵢ₋₁^{M}nᵢ possible combinations of deals. The software then examines each deal filtering out those combinations which fail to satisfy the constraints of Eqs. (12) and (13). Thus we refer to this aspect of the client software as filtering. Those combinations which pass the constraints can then be ranked (either by a human user or by additional company specific criteria (see reliability below and in section 6.4.7) added to the client software running at the vendor site) and sent back as responses to the original request.

We have operationally described how constraints and filters may be used to coordinate purchases from automated markets. The converse problem is the coordination of sell orders to automated markets. This is less likely to be problematic since usually there is only one sell order being responded to at any given time and thus there are no sell-side coordination problems. Nevertheless, if there are sell-side coordinating activities that must occur the same mechanism can be used. A separate set of logical and numerical constraints can be defined in IML for sell orders. Any responses to requests can then be checked against these constraints to ensure no responses are sent which violate the selling practices expressed through the IML constraints. Sell-side filters can be used to enforce preexisting contracts like specially arranged pricing for preferred customers. This may be particularly important when responses to requests are submitted automatically by software coupled to the companies ERP software. Typically such software will appropriately construct a response but when no human is present to check responses sell-side filters provide a final sanity check.

Other Applications of Constraints: An important consideration for any company in a supply chain is reliability. The company must be assured that its suppliers meet their obligations. In current supply chains this consideration is important enough that companies often limit themselves to a handful of trading partners with whom they maintain long term relationships. In order to fully reap the benefits of automated markets where many vendors may fulfill a need we need to resolve the issue of reliability. Filters are one way to address this issues. If for some historical reason a particular company doesn't like some suppliers the company may add these to be filtered. Thus the internal state Is, s} may include references to unwanted suppliers. Alternatively, reliability may be used to rank bids that pass all filters.

6.4.6 Practical Concerns

In this section we show how real world concerns of scalability, real-time performance, reliability, and security can be assured within the proposed e-commerce framework.

Scalability

The utility of an automated market is directly dependent on the liquidity (volume of trades) of the market. The greater the number of participants the greater the value to any individual participant. It is thus essential that the system scale gracefully to large numbers of market participants. Because the proposed e-commerce infrastructure is distributed scaling to large sizes is not a problem.

The market is driven by consumer demand pulled through the supply chain. Interfaces to consumer interaction can run locally on the consumer's computer as Java language applets. The central server (or servers) for consumer interaction is then only responsible for relaying consumer information (expressed in compact XML documents) into the top level market and returning the list of consumer responses to the appropriate user computer. The workload is shared across multiple machines with more machines involved the greater the number of consumers.

Similarly, the automated markets themselves serve mainly as relays of information and have little computational demands placed upon them. The markets send out requests, collect responses, and inform winning bidders of actual purchases. The bulk of the necessary computation is in the software which determines the parameters of the bids and responses. Since this software runs locally on each company's computer the system naturally exploits the parallelism inherent with increased vendor participation.

Real-Time Response

To be most useful to consumers it is important that consumer feedback is in real or near real time. This may be problematic on the rare occasions in which a query triggers a cascade down through submarkets. Before the top level market can clear (i.e. for responses to come back to the consumer) the tier one market must clear and before the tier one market can clear the tier two market must clear, etc. Fortunately, it is likely that all B2B markets will be monitored by software so that turnarounds on all markets will be fast. Market time-outs beyond which responses will not be accepted ensure timely responses from all submarkets.

Nevertheless, in situations where the response time is slow we can offer the consumer an immediate but approximate response and warn the consumer that the response may not be accurate. This can be accomplished by caching previous responses and estimating the response by interpolation of similar previous responses. Quick algorithms for the interpolation are easy to devise as long as the cached data can be accessed quickly as in any modern database.

6.4.7 Reliability

For any company to rely on the proposed infrastructure to run its supply chain it must be assured that the system is always up and running. For the system to be functioning for a company its own local server has to be up as well and all markets must be running. Each company is responsible for ensuring that its local servers are operating. The markets themselves will be served by a network of computers sharing the responsibility for managing transactions. The software which manages transactions can ensure that if a connection is broken during mid-transaction (e.g. if a computer goes down) it will be correctly reconstituted and resent. Such software is currently available from software companies.

6.4.8 Security

Whenever real dollars are being exchanged electronically there will always be important issues around security. We address each of these issues.

Commitment Assurance: It is important the every participant is confident that contra parties honor their commitments whether in terms of payment or delivery. We have described one mechanism that allows companies to automatically filter out those companies with whom they have had bad past experiences. It might also be expected that word of any party defaulting on its commitments would rapidly spread to all other participants making any default very costly for the offender.²⁶ If these mechanisms are insufficient the infrastructure may require each participant to pay an up front fee from which offenders compensate their contra partners. ²⁶We might post defaults publicly so that other parties rapidly become aware of this knowledge and add the offender to their filters.

Authentification: The system must ensure that all parties are who they say they are. This is an old problem faced by internet participants and has been solved satisfactorily by systems like PGP etc.

Privacy: It is also important that companies private data remains private. If a competitor could intercept a companies responses to the market it would have a distinct and unfair advantage. All communications will be strongly encrypted to assure that this can not occur.

Information Visibility: Similarly we may want different companies to have differing access to information.²⁷ For example data about consumer demand may be obtainable by a participant but only at a fee. This information may be served based on the authentification of the participant. ²⁷This will certainly be the case if we wish to charge for access to some of this information.

6.4.9 Optimization of the Supply Chain

The final ingredient in the infrastructure has been alluded to but not explicitly discussed. To achieve maximal benefit from the flexibility the proposed invention introduces at all levels of the supply chain, real-time optimization systems can be used. This innovation is described in a patent application, titled, “An Adaptive and Reliable System and Method for Operations Management”, application Ser. No. 09/345,441 filed Jul. 1, 1999 (the contents of which are herein incorporated by reference).

Coupling to ERP Software: The optimization systems monitor (in real-time) the state of the company and extrapolate from models of the company in its supply chain the optimal responses to requests that come in on the automated markets that the company supplies to. To achieve the best benefit, the servers or filters running at each company are coupled to ERP software to determine the best real-time response. The optimal response will be a function of the current instantaneous state of the company (as recorded in the ERP software) coupled with modeling and planning capabilities. A model of the likely future short term evolution of the state of the company may be used to best exploit the flexibility inherent in meeting the demand from the automated market. Such models might also take into account future expected demand and future responses from suppliers.

Another important optimization that might yield significant payoffs is in the tradeoff between making a response that is very close to meeting a requester's demand versus the savings obtained by perhaps being further from the requesters true desires.

6.4.10 Self-Organizing Supply Chains

In the procedure outlined above it is the responsibility of each company to define its business rules as expressed though its operating constraints and ranking criteria. This is not a unreasonable request and is a formalization of the company's current operating procedures. However, the present system does suggest a novel extension for the supply chain of the future. We can view the activities along a supply chain resulting in a finished good or service as an exercise in theorem proving in linear logic. Each company in the supply chain expresses its capabilities as predicates and functions (to include constraint) in linear logic. The finished good or service is a logical expression of a set of predicates. A path or method of assembly of the final good can then be represented as a proof of the logical expression representing the finished good or service. If the good can not be built then no such proof will be found. The precise manner in which the product is assembled is read off the proof net describing all the necessary steps. The beauty of this approach is its simplicity and the availability of theorem provers for linear logic. Though theorem proving for linear logic can be NP complete proofs of supply chains may be much simpler. To summarize: the mechanism of self-organization in the supply chain is proving the final good or service.

What are some of the axioms describing operations in the supply chain? There is shipping, manufacturing from components, etc. The state of the company includes inventory levels, lead times, etc.

6.4.11 Learning in the Infrastructure

There are many ways in which the data naturally recorded by the proposed infrastructure can be usefully used.

Prediction of customer demand: All the markets (both B2B and B2C) are rich sources of data for mining. Minimally, within any market we can use the data for both forecasting and inference of true customer desires (i.e. what they really want and now just what they are buying). The quantitative and nature of this market data should make mining it simpler than traditional data sources.

Inference of consumer preferences: The present invention also improves upon the efficiency of the end consumers search by aiding the search with learning tools. Based on the consumers interaction with the top-level market software can extrapolate to guess preferences and speed the search.

While the above invention has been described with reference to certain preferred embodiments, the scope of the present invention is not limited to these embodiments. One skilled in the art may find variations of these preferred embodiments which, nevertheless, fall within the spirit of the present invention, whose scope is defined by the claims set forth below.

What is claimed in the present invention is:

1. A method for discovery of trades between one or more buyers and one or more sellers comprising the steps of:
(a) expressing one or more terms of an ideal trade and one or more flexibilities by at least one of said buyers;
(b) expressing one or more capabilities by at least one of said sellers; and
(c) determining at least one optimal trade with respect to said one or more terms and said one or more flexibilities of said at least one buyer and said one or more capabilities of said at least one seller.

2. A method for discovery of trades between one or more buyers and one or more sellers as in 1, wherein said one or more terms comprise one or more members of the group consisting of continuous factors, discrete factors and range factors.

3. (New) A system for determining one or more trades between a buyer and one or more suppliers comprising:
(a) one or more variables defining a space of negotiation;
(b) a utility function of said one or more variables for expressing a utility of the one or more trades to the buyer over the space of negotiation comprising:
i. an ideal trade to the buyer defined by one or more ideal values corresponding to said one or more variables; and
ii. at least one flexibility in at least one of said variables expressing how the utility of the trade to the buyer varies in the space of negotiation for said ideal trade;
(c) one or more capabilities for defining a subspace of the negotiations space wherein the one or more suppliers have an ability to trade; and
(d) an optimizer determining at least one of the trades that is optimal with respect to said utility of the buyer subject to the capabilities of the one or more suppliers.

4. (New) A system for determining one or more trades between a buyer and one or more suppliers as in claim 3 wherein said one or more variables comprise one or more of the following:
(a) one or more continuous variables x₁ one or more discrete variables x and one or more range variables r.

5. (New) A system for determining one or more trades between a buyer and one or more suppliers as in claim 4 wherein each xᵢ of said one or more continuous variables x has an allowed range over which said each continuous variable xᵢ may vary xᵢεXᵢ=[xᵢ, \overline{x}ᵢ], wherein xᵢ is a lower bound of said continuous variable xᵢ and \overline{x}ᵢ is an upper bound of said continuous variable xᵢ;

6. (New) A system for determining one or more trades between a buyer and one or more suppliers as in claim 5 wherein each ᵢ of said one or more discrete variables has a value from a domain
ᵢεDᵢ=[1, . . . , dᵢ] where dᵢ≧0 is an integer giving the number of possible values that said discrete variable ᵢ may assume.

7. (New) A system for determining one or more trades between a buyer and one or more suppliers as in claim 6 wherein the space of negotiation comprises a tensor product
X₁\mathring{x} . . . \mathring{x}Xₙ_{_{c}}\mathring{x}D₁\mathring{x} . . . \mathring{x}Dₙ_{_{d}}.
wherein
n_{c} is the number of said continuous variables;
n_{d} is the number of said discrete variables;
Xᵢ is said allowed range of said continuous variable xᵢ; and
Dᵢ is said domain of said discrete variable ᵢ.

8. (New) A system for determining one or more trades between a buyer and one or more suppliers as in claim 4 wherein said utility function u((x, , r)) comprises an expression of a distance function d(x, , r) that defines a distance from said ideal trade in the space of negotiation.

9. (New) A system for determining one or more trades between a buyer and one or more suppliers as in claim 8 wherein said distance function comprises at least one of the following: a continuous distance, a discrete distance Z( ), and a range distance R.

10. (New) A system for determining one or more trades between a buyer and one or more suppliers as in claim 9 wherein said range distance depends on the value of at least one of said discrete variables .

11. (New) A system for determining one or more trades between a buyer and one or more suppliers as in claim 10 wherein said range distance is defined as:
R(r; )=Σᵢ₌₁ⁿ^{^{r}}Rᵢ(rᵢ; )
wherein:
r is an nᵣ vector of tables of preferred values of said one or more range variables, rᵢ=(rᵢ, \overline{r}ᵢ);
nᵣ is the number of said range variables; and
\overline{r}₁>rᵢ.

12. (New) A system for determining one or more trades between a buyer and one or more suppliers as in claim 10 wherein said range distance is a distance d(rᵢ, rⱼ) between said range variable rᵢ=(rᵢ, \overline{r}ᵢ) of the buyer and said range variable rⱼ=(rⱼ, \overline{r}ⱼ) of at least one of the suppliers.

13. (New) A system for determining one or more trades between a buyer and one or more suppliers as in claim 12 wherein said distance between said buyer range variables and said supplier range variable d(rᵢ, rⱼ) comprises an overlap between said buyer range variable and said supplier range variables, overlap (rᵢ, rⱼ).

14. (New) A system for determining one or more trades between a buyer and one or more suppliers as in claim 13, wherein said overlap is defined as
overlap(rᵢ,rⱼ)=ƒ_{μ}_{ⱼ}_{-σ}_{ⱼ}^{μ}^{^{j}}^{+σ}^{^{j}}dxN(x;rᵢ)N(x;rⱼ)
where
N(x;rⱼ) is a Gaussian in x centered at μⱼ=(rⱼ+\overline{r}ⱼ)/2 with standard deviation σⱼ=α(\overline{r}ⱼ−rⱼ);
N(x;rᵢ) is a Gaussian in x centered at μᵢ=(rᵢ+rᵢ)/2 with standard deviation σᵢ=α(\overline{r}ᵢ−rᵢ); and
α is a tunable parameter.

15. (New) A system for determining one or more trades between a buyer and one or more suppliers as in claim 14 wherein said range distance is defined as
$$R ( {r}_{i} , {r}_{j} ) = - ln [ \frac{overlap ( {r}_{i} , {r}_{j} )}{maxOverlap} ]$$
$$wherein$$
$$maxOverlap = \frac{erf [ \frac{1}{\sqrt{2}} ]}{\sqrt{2 π} ( {σ}_{i}^{2} + {σ}_{j}^{2} )}$$

16. (New) A system for determining one or more trades between a buyer and one or more suppliers as in claim 9 wherein said continuous distance is quadratic and is determined by a positive semi definite n_{c}×n_{c} matrix C⁻¹ wherein n_{c} is the number of said continuous variables.

17. (New) A system for determining one or more trades between a buyer and one or more suppliers as in claim 16 wherein said continuous distance is defined as
(x−μ( ))^{t}C⁻¹( )(x−μ( ))).
wherein
μ is an n_{c}-vector of ideal values of said continuous variables that may depend on said discrete variable .

18. (New) A system for determining one or more trades between a buyer and one or more suppliers as in claim 9 wherein said continuous distance is a convex function.

19. (New) A system for determining one or more trades between a buyer and one or more suppliers as in claim 9 wherein each of said discrete variables ᵢ has a value from a domain Dᵢ.

20. (New) A system for determining one or more trades between a buyer and one or more suppliers as in claim 19 wherein said discrete distance Z( ) maps a discrete space D₁ \mathring{x} . . . \mathring{x}Dₙ_{_{d}} onto the positive real line [0, ∞] wherein n_{d} is the number of said discrete variables.

21. (New) A system for determining one or more trades between a buyer and one or more suppliers as in claim 20 wherein said discrete distance Z( ) is defined as
$$d ( {C}_{rev} , {C}_{α} ) = \frac{{\sum }_{i = 1}^{D} {a}_{i } {w}_{i} {d}_{i} ( {C}_{rev} , {C}_{α} )}{{\sum }_{i = 1}^{D} {a}_{i}} \qquad ( 14 )$$
wherein
each Z_{i,j} is a table comprising dᵢjᵢ entries; and
dᵢdⱼ is the distance if said ith discrete variable has value Xi, conditional on said jth discrete variable having value xⱼ.

22. (New) A system for determining one or more trades between a buyer and one or more suppliers as in claim 21 wherein values in said tables Z_{i,j} are determined from one or more rankings by the buyer.

23. (New) A system for determining one or more trades between a buyer and one or more suppliers as in claim 22 wherein said discrete distance Z is defined as Z=−1 n[1−Z′].
wherein
Z′ is normalized to lie between 0 and 1.

24. (New) A system for determining one or more trades between a buyer and one or more suppliers as in claim 23 wherein said normalized distance Z′ is a linear scaling.

25. (New) A system for determining one or more trades between a buyer and one or more suppliers as in claim 23 wherein said normalized distance Z′ is an exponential scaling.

26. (New) A system for determining one or more trades between a buyer and one or more suppliers as in claim 23 wherein said normalized distance Z′ is an algebraic scaling.

27. (New) A system for determining one or more trades between a buyer and one or more supplies as in claim 9 wherein said discrete distance Z( ) is a function of one or more pairs of said discrete variables xᵢ, xⱼ.

28. (New) A system for determining one or more trades between a buyer and one or more suppliers as in claim 8 wherein said distance is generated from a ranking of preferred values for said one or more variables by the buyer.

29. (New) A system for determining one or more trades between a buyer and one or more suppliers as in claim 4 wherein said utility function u((x, , r)) expresses one or more tradeoffs among the one or more variables x, , r.

30. (New) A system for determining one or more trades between a buyer and one or more suppliers as in claim 8 further comprising one or more scaling factors, Q_{c}, Q_{d}, Qᵣ to normalize contributions of said at least one continuous variable x, said at least one discrete variable x, and said at least one range variable r to said utility function u((x, , r)) for defining a baseline wherein the one or more variables contribute equally to said utility.

31. (New) A system for determining one or more trades between a buyer and one or more suppliers as in claim 30 wherein said distance function with said normalized contribution is defined as:
d(x, , r))=d_{c}+Q_{d}d_{d}+Qᵣdᵣ
wherein
d_{c} is a contribution to said distance by said continuous variables,
Q_{d}d_{d} is a contribution to said distance by said discrete variables, and
Qᵣdᵣ is a contribution to said distance by said range variables.

32. (New) A system for determining one or more trades between a buyer and one or more suppliers as in claim 30 wherein values of said scaling factors are set so that average distances of said one or more from variables from said corresponding one or more ideal values are equal.

33. (New) A system for determining one or more trades between a buyer and one or more suppliers as in claim 32 wherein said average distance comprises utility-weighted average distances over said space of negotiation for placing more weight on better ones of the trades.

34. (New) A system for determining one or more trades between a buyer and one or more suppliers as in claim 33 wherein said utility-weighted average distances are defined as
$$\begin{matrix}( {d}_{r} ) ≡ \frac{{\sum }_{ϰ} {\sum }_{r} {\int }_{V} ⅆ {uQ}_{r} {d}_{r} exp [ - {Q}_{r} {d}_{r} - {Q}_{d} {d}_{d} - {d}_{c} ]}{{\sum }_{ϰ} {\sum }_{r} {\int }_{V} ⅆ u exp [ - {Q}_{r} {d}_{r} - {Q}_{d} {d}_{d} - {d}_{c} ]} \\ = {Q}_{r} {\sum }_{ϰ} \frac{exp [ - {Q}_{d} {d}_{d} ] {\sum }_{r} {d}_{r} exp [ - {Q}_{r} {d}_{r} ] {\int }_{V} ⅆ u exp [ - {d}_{c} ]}{{\sum }_{ϰ} exp [ - {Q}_{d} {d}_{d} ] {\sum }_{r} {d}_{r} exp [ - {Q}_{r} {d}_{r} ] {\int }_{V} ⅆ u exp [ - {d}_{c} ]}\end{matrix}$$
$$\begin{matrix}( {d}_{d} ) ≡ \frac{{\sum }_{ϰ} {\sum }_{r} {\int }_{V} ⅆ {uQ}_{d} {d}_{d} exp [ - {Q}_{r} {d}_{r} - {Q}_{d} {d}_{d} - {d}_{c} ]}{{\sum }_{ϰ} {\sum }_{r} {\int }_{V} ⅆ u exp [ - {Q}_{r} {d}_{r} - {Q}_{d} {d}_{d} - {d}_{c} ]} \\ = {Q}_{r} {\sum }_{ϰ} \frac{{d}_{d} exp [ - {Q}_{d} {d}_{d} ] {\sum }_{r} exp [ - {Q}_{r} {d}_{r} ] {\int }_{V} ⅆ u exp [ - {d}_{c} ]}{{\sum }_{ϰ} exp [ - {Q}_{d} {d}_{d} ] {\sum }_{r} exp [ - {Q}_{r} {d}_{r} ] {\int }_{V} ⅆ u exp [ - {d}_{c} ]}\end{matrix}$$
$$\begin{matrix}( {d}_{c} ) ≡ \frac{{\sum }_{ϰ} {\sum }_{r} {\int }_{V} ⅆ {ud}_{c} exp [ - {Q}_{r} {d}_{r} - {Q}_{d} {d}_{d} - {d}_{c} ]}{{\sum }_{ϰ} {\sum }_{r} {\int }_{V} ⅆ u exp [ - {Q}_{r} {d}_{r} - {Q}_{d} {d}_{d} - {d}_{c} ]} \\ = {Q}_{r} {\sum }_{ϰ} \frac{exp [ - {Q}_{d} {d}_{d} ] {\sum }_{r} exp [ - {Q}_{r} {d}_{r} ] {\int }_{V} ⅆ u {d}_{c} exp [ - {d}_{c} ]}{{\sum }_{ϰ} exp [ - {Q}_{d} {d}_{d} ] {\sum }_{r} exp [ - {Q}_{r} {d}_{r} ] {\int }_{V} ⅆ u exp [ - {d}_{c} ]}\end{matrix}$$
wherein
Σ indicates a repeated sum Σₓ_{₁} . . . Σₓ_{ₙ}_{_{d}} over all possible discrete trades;
Σᵣ indicates a sum over all of said range variables; and
Q_{c}=1 because Qᵣ is interpreted as Qᵣ/Q_{c} and Q_{d} is interpreted as Q_{d}/Q_{c}.

35. (New) A system for determining one or more trades between a buyer and one or more suppliers as in claim 34 wherein said scaling factors Q_{c}, Q_{d}, Qᵣ are determined from said utility-weighted average distances.

36. (New) A system for determining one or more trades between a buyer and one or more suppliers as in claim 30 further comprising one or more weights to enable the buyer to weight said contributions of said one or more variables to said utility.

37. (New) A system for determining one or more trades between a buyer and one or more suppliers as in claim 36 wherein said distance function comprises at least one of the following: a weighted continuous distance, a weighted discrete distance Z_{w}( ) and a weighted range distance.

38. (New) A system for determining one or more trades between a buyer and one or more suppliers as in claim 37 wherein said weighted continuous distance is defined as:
(x−μ( ))^{t}C_{w}⁻¹( )(x−μ( )).
wherein
C_{w}⁻¹=W_{c}C⁻¹W_{c};
W_{c} is a diagonal matrix formed from w_{c};
w_{c} is an n_{c}-vector of weight for said continuous variables; and
μ is an n_{c}-vector of ideal values for said continuous variables that may depend on said discrete variables .

39. (New) A system for determining one or more trades between a buyer and one or more suppliers as in claim 37 wherein said weighted discrete distance Z_{w}( ) is defined as:
Z_{w}( )=Σᵢ₌₁ⁿ^{^{d}}w_{d,i}{w_{d,i}Zᵢ( ᵢ)+Σ_{j=1(≢i)}ⁿ^{^{d}}w_{d,j}Z_{i,j}( ᵢ, ⱼ)}
wherein
Zᵢⱼ ( ᵢ, ⱼ) is the distance if said ith discrete variable has value ᵢ conditioned on said jth discrete variable having value ⱼ; and
w_{d;i} is the ith component of a n_{d} vector of weights for said discrete variables.

40. (New) A system for determining one or more trades between a buyer and one or more suppliers as in claim 37 wherein said weighted range distance is defined as
R_{w}(r)=Σᵢ₌₁ⁿ^{^{r}}w_{r;i}Rᵢ(rᵢ)
wherein nᵣ is the number of said range variables,
r is an nᵣ-vector of tuples of preferred values of said one or more range variables,
rᵢ=(rᵢ,\overline{r}₁); and
\overline{r}ᵢ>rᵢ.

41. (New) A system for determining one or more trades between a buyer and one or more suppliers as in claim 37 wherein said weighted distance function comprises at least one of the following: an n_{c}-vector of weights for said continuous variables, w_{c}, an n_{d}-vector of weights for said discrete variables, and an nᵣ-vector of weights for said range variables.

42. (New) A system for determining one or more trades between a buyer and one or more suppliers as in claim 41 wherein said weights are normalized so that
C_{w}¹=W_{c}C⁻¹W_{c}

43. (New) A system for determining one or more trades between a buyer and one or more suppliers as in claim 41 wherein values for said weights depend on values of said discrete variables, ᵢ.

44. (New) A system for determining one or more trades between a buyer and one or more suppliers as in claim 4 further comprising a total cost of ownership function expressing a total cost of membership to the buyer that varies over the negotiation space.

45. (New) A system for determining one or more trades between a buyer and one or more suppliers as in claim 44 wherein said total cost of ownership function comprises one or more cost contribution.

46. (New) A system for determining one or more trades between a buyer and one or more suppliers as in claim 45 wherein said one or more cost contributions comprise one or more of the following: piece part costs, freight costs, setup costs, quality assurance costs, repair costs, and revenue generated from the trade.

47. (New) A system for determining one or more trades between a buyer and one or more suppliers as in claim 44 wherein said total cost of ownership function is defined as C₀(x, , r; β)
wherein
β represents one or more other factors comprising one or more of the following: forecasted demand and current inventory levels.

48. (New) A system for determining one or more trades between a buyer and one or more suppliers as in claim 47 wherein said one or more other factors are extracted from at least one of the following: an enterprise resource planning system and a supply chain management system.

49. (New) A system for determining one or more trades between a buyer and one or more suppliers as in claim 48 wherein said one or more other factors are extracted in real time for enabling continuous, real time optimization.

50. (New) A system for determining one or more trades between a buyer and one or more suppliers as in claim 47 wherein minimization of said cost of ownership function C₀(x, , r; β) determines said ideal trade to the buyer: xₒₚₜ(β), ₒₚₜ(β), rₒₚₜ(β)

51. (New) A system for determining one or more trades between a buyer and one or more suppliers as in claim 50 wherein said at least one flexibility is determined by a Hessian matrix H=[h_{i;j}]
wherein h_{i;j} is defined as
$${{h}_{i , j} = \frac{{\partial }^{2} {C}_{o} ( x , ϰ , r ; β )}{\partial {x}_{i} \partial {x}_{j}} \vert}_{x = {x}_{opt} ( β ) , ϰ = {ϰ}_{opt} ( β ) , r = {r}_{opt} ( β )}$$

52. (New) A system for determining one or more trades between a buyer and one or more suppliers as in claim 3 wherein said one or more capabilities comprise one or more of the following: price discounts on large volume orders, and variation in delivery as a function of price.

53. (New) A system for determining one or more trades between a buyer and one or more suppliers as in claim 8 wherein said one or more capabilities specify one or more of the following:
one or more continuous capabilities, one or more discrete capabilities, and allowed values for said range variables.

54. (New) A system for determining one or more trades between a buyer and one or more suppliers as in claim 53 wherein said allowed values for said ranges variables contribute to said distance function.

55. (New) A system for determining one or more trades between a buyer and one or more suppliers as in claim 53 wherein said allowed values for said range variables comprise one or more pairs (rⱼ, \overline{r}ⱼ) wherein rⱼ is a lower bound for the jth one of said range variable and \overline{r}ⱼ is an upper bound for the jth one of said range variable.

56. (New) A system for determining one or more trades between a buyer and one or more suppliers as in claim 52 wherein said continuous capabilities are one or more responses from said suppliers to a request for the buyer.

57. (New) A system for determining one or more trades between a buyer and one or more suppliers as in claim 56 further comprising a vector-valued function f(x^{(b)}, x^{(s)}, ) to determine said one or more supplier responses wherein
x^{(b)} is said buyer request and
x^{(s)} is at least a previous one of said supplier responses.

58. (New) A system for determining one or more trades between a buyer and one or more suppliers as in claim 57 wherein said vector-valued function f(x^{(b)}, x^{(s)}, ) comprises one or more components fᵢ for corresponding ones of said continuous variables:
xᵢ^{(s)}=fᵢ(x^{(b)}, x^{(s)}).

59. (New) A system for determining one or more trades between a buyer and one or more suppliers as in claim 52 wherein said one or more components, fᵢ are piecewise linear functions.

60. (New) A system for determining one or more trades between a buyer and one or more suppliers as in claim 59 wherein said one or more components, fᵢ are specified with one or more breakpoints.

61. (New) A system for determining one or more trades between a buyer and one or more suppliers as in claim 53 wherein said one or more discrete capabilities of said suppliers comprise one or more constraints from said suppliers on said one or more discrete variables.

62. (New) A system for determining one or more trades between a buyer and one or more suppliers as in claim 3 wherein said one or more capabilities are represented by one or more piecewise linear functions.

63. (New) A system for determining one or more trades between a buyer and one or more suppliers as in claim 4 further comprising one or more constraints involving said one or more variables which must be satisfied for the buyer and at least one of the sellers to trade.

64. (New) A system for determining one or more trades between a buyer and one or more suppliers as in claim 63 wherein said one or more constraints comprise one or more of the following: discrete constraints for expressing one or more allowed and/or disallowed combinations of values for said discrete variables and continuous constraints for setting one or more requirements on said continuous variable x.

65. (New) A system for determining one or more trades between a buyer and one or more suppliers as in claim 64 wherein said continuous constraints from the buyer are linear.

66. (New) A system for determining one or more trades between a buyer and one or more suppliers as in claim 64 wherein said continuous constraints comprise at least one of inequality constraints and equality constraints.

67. (New) A system for determining one or more trades between a buyer and one or more suppliers as in claim 64 wherein said continuous constraints depend on values of said discrete variables, .

68. (New) A system for determining one or more trades between a buyer and one or more suppliers as in claim 63 wherein said one or more constraints comprise one or more of the following:
required delivery time, and an unacceptable color.

69. (New) A system for determining one or more trades between a buyer and one or more suppliers as in claim 64 wherein at least one of said continuous constraints depend on values of at least one of said discrete variables .

70. (New) A system for determining one or more trades between a buyer and one or more suppliers as in claim 3 wherein said determining at least one of the trades that is optimal step comprises the steps of:
selecting one of said suppliers;
determining at least one of the trades that corresponds to a maximum value of said utility of the buyer and that is within the capabilities of said selected supplier.

71. (New) A system for determining one or more trades between a buyer and one or more suppliers as in claim 70 wherein said determining at least one of the trades that is optimal step further comprises the steps of:
selecting another of said suppliers; and
repeating said determining at least one of the trades step for said another selected supplier.

72. (New) A system for determining one or more trades between a buyer and one or more suppliers as in claim 71 wherein said determining at least one of the trades that is optimal step further comprises the steps of:
choosing at least of the suppliers having the highest said maximum value of said utility of the buyer.

73. (New) A system for determining one or more trades between a buyer and one or more suppliers as in claim 72 further comprising a subsystem to perform said determined trade between the buyer and the chosen supplier.

74. (New) A system for determining one or more trades between a buyer and one or more suppliers as in claim 3 further comprising a subsystem to perform said determined trade.

75. (New) A system for determining one or more trades between a buyer and one or more suppliers as in claim 3 wherein said utility comprises at least one of the following: quantitative factors and qualitative factors.

76. (New) A system for determining one or more trades between a buyer and one or more suppliers as in claim 4 wherein said determining at least one of the trades that is optimal step further comprises the step of:
minimizing a distance from said ideal trade.

77. (New) A system for determining one or more trades between a buyer and one or more suppliers as in claim 76 wherein said distance comprises one or more of the following: a continuous component, a discrete component, and a range component.

78. (New) A system for determining one or more trades between a buyer and one or more suppliers as in claim 77 wherein said minimizing a distance from said ideal trade step comprises the steps of:
determining values of said continuous variables that minimize said distance for one or more settings of said discrete variables.

79. (New) A system for determining one or more trades between a buyer and one or more suppliers as in claim 78 further comprising the steps of:
representing said distance by a function of said discrete variables; and
determining an optimal one of said settings of said discrete variables by minimizing said function of said discrete variables.

80. (New) A system for determining one or more trades between a buyer and one or more suppliers as in claim 78 wherein said determining values for said continuous variable step is performed under one or more constraints on said continuous variables.

81. (New) A system for determining one or more trades between a buyer and one or more suppliers as in claim 79 wherein said representing said determining an optimal one of said settings of said discrete variables step is performed under one or more constraints on said discrete variables.

82. (New) A system for determining one or more trades between a buyer and one or more suppliers as in claim 4 further comprising means for aggregating at least one of the suppliers to participate in said trade with the buyer.

83. (New) A system for determining one or more trades between a buyer and one or more suppliers as in claim 82 wherein said aggregating means perform the steps of:
determining one or more subsets of said suppliers that satisfy one or more constraints on said discrete variables.

84. (New) A system for determining one or more trades between a buyer and one or more suppliers as in claim 83 wherein said one or more discrete variable constraints comprise at least one of the following: buyer discrete variable constraints and seller discrete variable constraints.

85. (New) A system for determining one or more trades between a buyer and one or more suppliers as in claim 83 further comprising the step of optimizing over said continuous variables to determine an optimal one of said subset of buyers.

86. (New) A grammar for a system that determines one or more trades between a buyer and one or more suppliers comprising:
(a) one or more capability rules representing one or more capabilities of said suppliers to trade with the buyer;
(b) one or more preference rules representing one or more preferences of the buyer; and
(c) one or more match rules representing matches between said one or more capabilities and said one or more preferences.

87. (New) A grammar for a system that determines one or more trades as in claim 86 wherein said one or more capabilities of said suppliers are specific to particular ones of said buyers.

88. (New) A grammar for a system that determines one or more trades as in claim 86 wherein said capability rules comprise one or more of the following:
(a) a discrete variable rule for representing a description of a discrete variable;
(b) a continuous variable rule for representing a description of a continuous variable; and
(c) a range variable rule for representing a description of a range variable.

89. (New) A grammar for a system that determines one or more trades as in claim 88 wherein said description of the continuous variable comprises at least one of a minimum value and a maximum value for the continuous variable.

90. (New) A grammar for a system that determines one or more trades as in claim 88 wherein said one or more capability rules comprise one or more constraint rules representing constraints on value of at least one of said discrete variables, and said continuous variables.

91. (New) A grammar for a system that determines one or more trades as in claim 89 wherein said one or more constraint rules comprise at least one matrix for representing said constraints.

92. (New) A grammar for a system that determines one or more trades as in claim 90 wherein said constraints on said values of said discrete variables comprise one or more permitted value continuations for the discrete variables.

93. (New) A grammar for a system that determines one or more trades as in claim 88 wherein said range variable description comprises at least one of a minimum value and a maximum value for the range variable.

94. (New) A grammar for a system that determines one or more trades as in claim 90 wherein said constraints on said values of said continuous variables comprise one or more of the following: an inequality, an equality, a linear constraint, and a non-linear constraint.

95. (New) A grammar for a system that determines one or more trades as in claim 86 wherein said one or more capability rules further comprise an aggregation flag indicating a willingness of the supplier to participate in an aggregation for the buyer.

96. (New) A grammar for a system that determines one or more trades as in claim 86 wherein said preferences of the buyer are specific to at least one of said suppliers.

97. (New) A grammar for a system that determines one or more trades as in claim 86 wherein said preference rules comprise one or more of the following:
(a) a continuous variable rule for representing a description of a continuous variable;
(b) a discrete variable rule for representing a description of a discrete variable, and
(c) a range variable rule for representing a description of a range variable.

98. (New) A grammar for a system that determines one or more trades as in claim 97 wherein said preference rules further comprise one or more weights for representing an importance of at least one of said discrete variable, said continuous variable and said range variable.

99. (New) A grammar for a system that determines one or more trades as in claim 97 wherein said preference rules comprise at least one of the following:
(a) a first field representing an ideal value for said range variable;
(b) a second field representing an ideal value for said continuous variable; and
(c) a matrix representing one or more tradeoffs of said continuous variables.

100. (New) A grammar for a system that determines one or more trades as in claim 97 wherein said preference rules comprise a matrix representing one or more tradeoffs of said discrete variables.

101. (New) A grammar for a system that determines one or more trades as in claim 97 further comprising at least one aggregation rule comprising at least one of the following:
(a) a list of one or more of said suppliers that can participate in the one or more trades with the buyer;
(b) one or more contribution type fields for specifying contribution types of said or more continuous variables; and
(c) one or more constraints around the aggregation.

102. (New) A grammar for a system that determines one or more trades as in claim 101 wherein said contribution types comprise at least of the following: sum, average and zero.

103. (New) A grammar for a system that determines one or more trades as in claim 101 wherein said constraints around the aggregation comprise requiring that all orders arrive on the same day.

104. (New) A grammar for a system that determines one or more trades as in claim 99 wherein said one or more preferences rules further comprise:
(a) at least one mask for allowing at least one of said ideal value for said range variable, said continuous variable, and said one or more tradeoffs of said continuous variables to be dependent on values of said discrete variables.

105. (New) A grammar for a system that determines one or more trades as in claim 88 wherein said one or more match rules comprise at least one of the following:
(a) a single supplier match rule describing at least one optimal one of said one or more trades with a single one of the suppliers; and
(b) an aggregate supplier match rule describing at least one optimal one of said one or more trades with an aggregation of said suppliers;

106. (New) A grammar for a system that determines one or more trades as in claim 105 wherein said single supplier match rule comprises at least one of the following:
(a) an identifier for indicating said supplier of said trade;
(b) a utility for indicating a utility of said trade;
(c) a feasibility flag for indicating whether a feasible one of the trades with said single supplier was found;
(d) a continuous variable field indicating a value for said continuous variable;
(e) a discrete variable field indicating a value for said discrete variable;
(f) a range variable field indicating a value for said range variable; and
(g) a cost factors field indicating constituent costs contributing to a total cost of ownership at said trade.

107. (New) A grammar for a system that determines one or more trades as in claim 104 wherein said aggregate supplier match rule comprises at least one of the following:
(a) a utility field indicating a utility of said trade;
(b) a feasibility field indicating whether a feasible one of said trades with the aggregation of suppliers was found;
(c) a cost factors field indicating constituent costs contributing to a total cost of ownership at said trade; and
(d) a list of one or more trade parameters for said suppliers in the aggregation.

108. (New) A grammar for a system as in claim 107 wherein said list of trade parameters comprise at least one of the following:
(a) an identifier for identifying one of said suppliers in the aggregation;
(b) a continuous variable field indicating a value for said continuous variable;
(c) a discrete variable field indicating a value for said discrete variable;
(d) a range variable field indicating a value for said range variable.

109. (New) A method for determining at least one preference by one or more buyers for one or more goods and/or services from one or more sellers comprising the steps of:
(a) specifying one or more initial preferences by said one or more buyers;
(b) responding to said one or more initial preferences by said one or more sellers with one or more offers; and
(c) revising said one or more initial preferences based on said one or more offers by said one or more buyers to specify one or more revised preferences.

110. (New) A method for determining at least one preference by one or more buyers for one or more goods and/or services from one or more sellers as in claim 109 further comprising the steps of:
(a) responding to said one or more revised preferences by said one or more sellers with one or more revised offers; and
(b) revising said one or more revised preferences based on said one or more revised offers by said one or more buyers.

111. (New) A method for determining at least one preference by one or more buyers for one or more goods and/or services from one or more sellers as in claim 110 further comprising the steps of iteratively repeating said responding to said one or more revised preferences step and said revising said one or more revised preferences step to implicitly determine said one or more preferences by said one or more buyers.

112. (New) A method for determining at least one preference by one or more buyers for one or more goods and/or services from one or more sellers as in claim 109 wherein said one or more initial preferences and/or said one or more revised preferences comprise one or more dimensions.

113. (New) A method for determining at least one preference by one or more buyers for one or more goods and/or services from one or more sellers as in claim 112 wherein said one or more initial preferences and/or said one or more revised preferences comprise one or more weights corresponding to said one or more dimensions wherein each of said weights specifies an importance of said corresponding dimension to the one or more buyers.

114. (New) A method for determining at least one preference by one or more buyers for one or more goods and/or services from one or more sellers as in claim 109 wherein said one or more initial preferences and/or said one or more revised preferences comprise one or more constraints.

115. (New) A method for determining at least one preference by one or more buyers for one or more goods and/or services from one or more sellers as in claim 114 further comprising the step of:
(a) filtering said one or more offers from the one or more sellers to pass only those of said one or more offers that satisfy said one or more constraints

116. (New) A method for determining at least one preference by one or more buyers for one or more goods and/or services from one or more sellers as in claim 112 further comprising the step of:
(a) sorting said one or offers at the one or more buyers based on at least one of said dimensions.

117. (New) A method for determining at least one preference by one or more buyers for one or more goods and/or services from one or more sellers as in claim 112 further comprising the steps of:
(a) computing a distance between said one or more initial preferences and said one or more offers.

118. (New) A method for determining at least one preference by one or more buyers for one or more goods and/or services from one or more sellers as in claim 117 further comprising the steps of:
(a) sorting said one or more offers at the one or more buyers based on said distance.

119. (New) A method for determining at least one preference by one or more buyers for one or more goods and/or services from one or more sellers as in claim 112 further comprising the steps of:
(a) computing a distance function between said one or more revised preferences and said one or more offers.

120. (New) A method for determining at least one preference by one or more buyers for one or more goods and/or services from one or more sellers as in claim 119 further comprising the steps of sorting said one or more offers at the one or more buyers based on said distance.

121. (New) A method for determining at least one preference by one or more buyers for one or more goods and/or services from one or more sellers as in claim 117 wherein said distance is defined as
$$Z ( ϰ ) = {\sum }_{i = 1}^{{n}_{d}} \{ {Z}_{i} ( {ϰ}_{i} ) + {\sum }_{j = 1 ( \neq i )}^{{n}_{d}} {Z}_{i , j} ( {ϰ}_{i} , {ϰ}_{j} ) \}$$
wherein
Cᵣₑᵥ is said revised preference;
C_{α} is said one or more offers;
D is the number of said dimensions;
i is an index of said dimensions;
αᵢ is a binary variable indicating which of said dimensions are used;
wᵢ is one of said weights corresponding to said ith dimension; and
d(Cᵣₑᵥ, C_{α}) is a component of said distance for said ith dimension.

122. (New) A method for determining at least one preference by one or more buyers for one or more goods and/or services from one or more sellers as in claim 120 wherein said ith component of said distance comprises at least one of a similarity component and a brand name component.

123. (New) A method for determining at least one preference by one or more buyers for one or more goods and/or services from one or more sellers as in claim 122 wherein said similarity component is assymetric.

124. (New) A method for supplying one or more goods and/or services by one or more suppliers in fulfillment of one or more orders comprising the steps of:
(a) determining one or more components of the goods and/or services that are needed for the fulfillment of said one or more orders of a first one of said suppliers
(b) determining one or more constraints on the fulfillment of said one or more orders;
(c) sending one or more requests for said one or more components to at least one other of said one or more suppliers; and
(d) determining one or more combinations of one or more responses to said one or more requests for said one or more components, that satisfy one or more contraints.

125. A method for supplying one or more goods and/or services as in claim 124 wherein said determining one or more components of the goods and/or services step comprises the step of determining those of said one or more components that are not present at said first supplier by examining a state of said first supplier.

126. (New) The method of supplying one or more goods and/or services as in claim 125 wherein said state of said first supplier comprises one or more of the following: an inventory of said one or more components of said first supplier and one or more references to unwanted ones of said suppliers.

127. (New) The method of supplying one or more goods and/or services as in claim 124 wherein said constraints comprise one or more of the following: one or more logical constraints and one or more numerical constraints.

128. (New) A method for supplying one or more goods and/or services as in claim 127 wherein said logical constraints are expressed in at least one of linear logic and Boolean logic.

129. (New) A method for supplying one or more goods and/or services as in claim 127 wherein said logical constraints comprise a logical AND of two or more events in two or more markets.

130. (New) A method for supplying one or more goods and/or services as in claim 129 wherein said two or more events comprise an order for at least one of said components and transportation of said at least one component.

131. (New) The method for supplying one or more goods and/or services as in claim 127 wherein said numerical constraints comprise an ordering of two or more events in two or more markets.

132. (New) The method for supplying one or more goods and/or services as in claim 131 wherein said two or more events comprise a completion of at least one of said components and an available pick-up time for transportation of said at least one component.

133. (New) The method for supplying one or more goods and/or services as in claim 127 wherein said numerical constraints comprise at least one requirement that a total expenditure on said components is less than a threshold.

134. (New) The method for supplying one or more goods and/or services as in claim 124 further comprising the step of:
(a) ranking said one or more combinations that satisfy said one or more constraints according to one or more criteria.

135. (New) The method for supplying one or more goods and/or services as in claim 134 wherein said criteria comprise a reliability of said one or more suppliers.

136. (New) The method for supplying one or more goods and/or services as in claim 124 wherein said one or more requests for said one or more components comprise a time-out period.

137. (New) The method for supplying one or more goods and/or services as in claim 136 further comprising the step of:
(a) filtering those of said responses that arrive after said time-out period.

138. (New) The method for supplying one or more goods and/or services as in claim 124 wherein said suppliers operate in one or more markets.

139. (New) The method for supplying one or more goods and/or services as in claim 138 wherein said one or more requests comprise a first identifier and a second identifier wherein said second identifier identifies said market of said first supplier.

140. (New) The method for supplying one or more goods and/or services as in claim 139 further comprising the step of forecasting demand at said one or more suppliers.

141. (New) The method for supplying one or more goods and/or services as in claim 140 wherein said forecasting demand step comprises the step of:
(a) counting those of said requests having different ones of said first identifier and said second identifier for avoiding spurious amplication of the demand.
